(19) United States
(12) Patent Application Publication
(10) Pub. No.: US 2013/0216867 A1
(43) Pub. Date: Aug. 22, 2013

(54) Electrochemical energy converter device with a cell housing, battery with at least two of these electrochemical energy converter devices and alsomethod for producing an electrochemical energy converter device

(71) Applicant: Li-Tec Battery GmbH, (US)

(72) Inventors: Tim Schaefer, Harztor (DE); Werner Hufenbach, Dresden (DE); Marco Zichner, Dresden (DE); Hans-Walter Praas, Radebeul (DE)

(73) Assignee: LI-TEC BATTERY GMBH, Kamenz (DE)

(21) Appl. No.: 13/750,090

(22) Filed: Jan. 25, 2013

Related U.S. Application Data
(60) Provisional application No. 61/590,825, filed on Jan. 26, 2012.
(60) Provisional application No. 61/593,875, filed on Feb. 2, 2012.

(30) Foreign Application Priority Data
Jan. 26, 2012 (DE) 10 2012 001 440.6
Feb. 2, 2012 (DE) 10 2012 002 051.1

(51) Int. Cl. H01M 10/0525; H01M 10/48; H01M 10/02; H01M 2/12; H02J 7/00; H01M 2/24; H01M 2/30; H01M 2/20; H01M 10/46; H01M 10/058; H01M 2/02; H01M 10/50

(52) U.S. Cl. CPC H01M 10/0525; H01M 2/024; H01M 10/48; H01M 10/02; H01M 2/12; H01M 10/502; H01M 2/24; H01M 2/305; H01M 2/206; H01M 10/46; H01M 10/058; H02J 7/0047
USPC 429/7; 429/163; 429/90; 429/53; 429/120; 429/179; 429/61; 29/623.1; 320/134

(57) ABSTRACT

An electrochemical energy converter device (1) with at least one in particular rechargeable electrode assembly (2), which is provided to provide electrical energy at least intermittently to a consumer in particular, which has at least two electrodes (3, 3a) of different polarity, with at least a current conduction device (4, 4a), which is provided to be electrically, preferably materially connected to one of the electrodes (3, 3a) of the electrode assembly (2), with a cell housing (5) with a first housing part (6), wherein the first housing part (6) is provided to encompass the electrode assembly (2) at least in certain areas.

The present invention relates to an electrochemical energy converter device, in the following also called a converter cell, with a cell housing, a battery with at least two of these electrochemical energy converter devices and also a method for producing an electrochemical energy converter device. The invention is described in connection with lithium-ion batteries for supplying automotive drives. It is pointed out that the invention can also be used independently of the chemistry of the converter cell, independently of the design of the battery or independently of the type of the drive supplied.

Batteries with a plurality of converter cells for supplying automotive drives are known from the prior art. Conventional converter cells have an electrode assembly with at least two electrodes of different polarity and a separator. The separator separates or spaces the electrodes of different polarity. Further, conventional converter cells have a cell housing, which encompasses the electrode assembly at least in certain areas. Further, conventional converter cells have at least two current conduction devices which are each electrically connected to an electrode of the electrode assembly.

The high outlay for producing some designs of converter cells is sometimes found to be problematic.

It is an object of the invention to provide a converter cell which can be produced with low outlay or costs.

The object is achieved by means of an electrochemical energy converter device according to claim 1. Claim 14 describes a battery with at least two electrochemical energy converter devices according to the invention. The object is also achieved by means of a production method for an electrochemical energy converter device according to claim 15. Developments of the invention which are to be preferred are the subject of the subclaims.

An electrochemical energy converter device according to the invention, in the following also called a converter cell, has at least one in particular rechargeable electrode assembly. The at least one electrode assembly is provided to provide electrical energy at least intermittently to a consumer in particular. The electrode assembly has at least two electrodes of different polarity. The converter cell has one, two or a plurality of current conduction devices, wherein at least one or a plurality of these current conduction devices are provided to be electrically, preferably materially, connected to one of the electrodes of the electrode assembly. The converter cell has a cell housing with at least one in particular first housing part, wherein the cell housing is provided to encompass the electrode assembly at least in certain areas. The first housing part has at least one functional device which is provided to support the release of energy from the electrode assembly, in particular to a consumer. The functional device is operatively connected to the electrode assembly, in particular for the absorption of energy. The first housing part has at least one first support element, which is provided to delimit the at least one functional device with respect to the surroundings of the converter cell. The first support element is used in particular to support the at least one functional device, i.e. in particular to counteract an undesired relative displacement of the at least one functional device with respect to the converter cell. The first support element is used in particular to protect the at least one functional device from damaging influences from the surroundings.

Preferably, the at least one electrode assembly is provided to convert chemical energy into electrical energy at least intermittently. Preferably, the at least one electrode assembly is provided to convert supplied electrical energy in particular into chemical energy at least intermittently.

In the case of construction according to the invention of the first housing part, the functional device assumes a plurality of functions in particular relating to the operation of the converter cell or the electrode assembly, which are fulfilled in known designs of converter cells by means of discrete components. A plurality of discrete components or functional elements are combined in the at least one functional device in particular as a separate functional assembly. Thus, fewer modules are required for producing the converter cell according to the invention, as a result of which the outlay during production or assembly is reduced. Thus, the fundamental object is achieved.

Further, the converter cell according to the invention offers the advantage of increased durability, in that the first support element protects the functional device lying therebelow from mechanical damage, in particular due to a foreign body acting on the cell housing. Further, the converter cell according to the invention offers the advantage of increased durability, in that the first support element improves the cohesion of the functional device, in particular in the case of accelerations or vibrations during the operation of the converter cell.

In the sense of the invention, an electrode assembly is understood as meaning a device which is used in particular for providing electrical energy.

The electrode assembly has at least two electrodes of different polarity. These electrodes of different polarity are spaced by means of a separator, wherein the separator is conductive for ions, but not for electrons. Preferably, the electrode assembly is essentially constructed to be cuboidal. Preferably, the electrode assembly is in particular materially connected to two of these current conduction devices of different polarity which are used at least indirectly for electrical connection to at least one adjacent electrode assembly and/or at least indirectly for electrical connection to the consumer.

Preferably, at least one of these electrodes has an in particular metallic collector film and also an active material. The active material is applied onto the collector film at least on one side. When charging or discharging the electrode assembly, electrons are exchanged between the collector film and active material. Preferably, at least one contact lug is in particular materially connected to the collector film. Particularly preferably, a plurality of contact lugs are in particular materially connected to the collector film. This configuration offers the advantage that the current per contact lug is reduced.

Preferably, at least one of these electrodes has an in particular metallic collector film and also two active materials of different polarity which are arranged on various surfaces of the collector film and are spaced by means of the collector film. The term “bi-cell” is also customary for this arrangement of active materials. When charging or discharging the electrode assembly, electrons are exchanged between the collector film and active material. Preferably, at least one contact lug is in particular materially connected to the collector film. Particularly preferably, a plurality of contact lugs are in particular materially connected to the collector film. This configuration offers the advantage that the number of electrons which flow through a contact lug per unit time is reduced.

Two electrodes of different polarity are spaced in the electrode assembly by means of a separator. The separator is permeable for ions but not for electrons. Preferably, the separator contains at least one part of the electrolyte or the conductive salt. Preferably, the electrolyte is essentially formed without a liquid portion in particular after the closure of the converter cell. Preferably, the conductive salt contains lithium. Particularly preferably, lithium ions are embedded or intercalated into the negative electrode during charging and released again during discharging.

Electrode assembly is preferably configured to convert supplied electrical energy into chemical energy and to store the same as chemical energy. The electrode assembly is preferably configured to convert stored chemical energy in particular into electrical energy before the electrode assembly supplies this electrical energy to a consumer. One then also speaks of a rechargeable electrode assembly. Particularly preferably, lithium ions are embedded or intercalated into the negative electrode during charging and released again during discharging.

According to a first preferred configuration, the electrode assembly is constructed as an electrode winding, in particular as an essentially cylindrical electrode winding. Preferably, this electrode assembly is rechargeable. This configuration offers the advantage of simple producibility, in particular in that strip-shaped electrodes can be processed. This configuration offers the advantage that the nominal charging capacity, for example specified in ampere hours [Ah] or watt hours [Wh], less often in coulombs [C], can be increased in a simple manner by means of further windings. Preferably, the electrode assembly is constructed as a flat electrode winding. This configuration offers the advantage that the same can be arranged in a space-saving manner next to a further flat electrode winding in particular within a battery.

According to a further preferred configuration, the electrode assembly is constructed as an essentially cuboidal electrode stack. Preferably, this electrode assembly is rechargeable. The electrode stack has a predetermined sequence of stack sheets, wherein each pair of electrode sheets of different polarity are separated by a separator sheet. Preferably, each electrode sheet is in particular materially connected to a current conduction device, particularly preferably constructed integrally with the current conduction device. Preferably, electrode sheets of the same polarity are in particular electrically connected to one another via a common current conduction device. This configuration of the electrode assembly offers the advantage that the nominal charging capacity, for example specified in ampere hours [Ah] or watt hours [Wh], less often in coulombs [C], can be increased in a simple manner by adding further electrode sheets. Particularly preferably, at least two separator sheets are connected to one another and encompass a delimiting edge of an electrode sheet. An electrode assembly of this type with a separate, in particular meandering separator is described in WO 2011/020545. This configuration offers the advantage that a parasitic current originating from this delimiting edge to an electrode sheet of a different polarity is counteracted.

According to a third preferred configuration, the electrode assembly is constructed to supply electrical energy with absorption of at least one continually supplied fuel and an oxidising agent, called process fluids in the following, the chemical reaction thereof to form an educt, in particular supported by at least one catalyst, and emitting the educt. In the following, the electrode assembly according to this preferred configuration is also called the converter assembly. The converter assembly is constructed as an essentially cuboidal electrode stack and has at least two in particular sheet-like electrodes of different polarity. Preferably, at least the first electrode is coated at least in certain areas with a catalyst. The electrodes are spaced, preferably by means of a separator or a membrane, which is permeable for ions, but not for electrons. Further, the energy converter has two fluid-conveying devices which are in each case arranged adjacently to the electrodes of different polarity and provided to supply the process fluids to the electrodes. Preferably, at least one of the fluid-conveying devices is provided to drain the educt. The converter assembly has at least one of the following sequences: fluid-conveying device for the fuel—electrode of first polarity—membrane—electrode of second polarity—fluid-conveying device for the oxidising agent, in particular also for the educt. Preferably, a plurality of these sequences are electrically connected in series for increased electric voltage. During the operation of the energy converter, the fuel of the first electrode is supplied in particular as a fluid flow through channels of the first fluid-conveying device. At the first electrode the fuel is ionised with the release of electrons. The electrons are carried away via the first electrode, in particular via one of the current conduction devices, in particular in the direction of an electrical consumer or an adjacent converter cell. The ionised fuel migrates through the membrane which is permeable for ions to the second electrode. The oxidising agent is supplied to the second electrode, in particular as a fluid flow through channels of the second fluid-conveying device. At the second electrode coincide: the oxidising agent, the ionised fuel and also electrons from the first electrical consumer or an adjacent converter cell. The chemical reaction to form the educt, which is preferably conveyed away through channels of the second fluid-conveying device, takes place at the second electrode.

In the sense of the invention, a current conduction device is to be understood as meaning a device which is in particular used for the conduction of electrons between one of the electrodes of the electrode assembly and a consumer or between one of the electrodes and an adjacent converter cell. To this end, the current conduction device is electrically, preferably materially connected to one of the electrodes of the electrode assembly. Preferably, the current conduction device is at least indirectly connected to a consumer which is to be supplied.

The current conduction device has an electrically conductive region with a metallic material, preferably aluminium and/or copper, particularly preferably a coating with nickel in certain areas. This configuration offers the advantage of reduced contact resistance. Preferably, the current conduction device is constructed solidly using a metallic material. Preferably, the material of the current conduction device corresponds to the material of the collector film of the electrode, to which the current conduction device is in particular materially connected. This configuration offers the advantage of reduced contact corrosion between current conduction device and collector film.

The current conduction device has a second region which is arranged inside the converter cell. The second region is electrically, preferably materially connected to at least one electrode of the electrode assembly, preferably to all electrodes of the same polarity.

Preferably, the second region has at least one contact lug. The contact lug is in particular materially connected to one of the electrodes of the electrode assembly, in particular to the collector film thereof. The contact lug is constructed as an electrically conductive strip, preferably as a metal film. This configuration offers the advantage that an offset between a plane of symmetry through the region of the current conduction device which extends into the surroundings of the converter cell and a plane through this electrode or collector film can be compensated. Particularly preferably, the second region has a plurality of contact lugs. The contact lugs offer a plurality of current paths to the same electrode, as a result of which the current density is advantageously reduced, or to various electrodes of the same polarity of the electrode stack, as a result of which a parallel connection of the electrodes of the same polarity is formed.

Preferably, the current conduction device also has a first region which extends into the surroundings of the converter cell. The first region is electrically at least indirectly connected to one of the consumers to be supplied or to a second, in particular adjacent converter cell, in particular via a connection device, preferably via a contact rail, flexible connector or a connection cable. According to a preferred configuration, the first region is constructed as a metal plate or as a plate with a metallic coating. This configuration offers the advantage that a mechanically stable, essentially flat surface is present for an electrical connection to a connection device which is simple and/or as durable as possible.

Preferably, the current conduction device has an essentially plate-shaped, metallic or metal-coated current conductor. In the second region of the current conduction device, the current conductor is in particular materially connected to in particular all contact lugs of the same polarity. Preferably, the material of the current conductor corresponds to the material of the contact lug. This configuration offers the advantage that the current conductor can be constructed in a more mechanically stable manner for connection to a connection device and or one of the housing parts than a film-like contact lug could be constructed. Thus, the durability of the converter cell is improved. Further, this configuration offers the advantage that the current conductor can be connected to the cell housing before the electrode assembly with contact lugs fastened thereon is supplied to the cell housing.

According to a preferred embodiment, the current conductor extends out of the cell housing also into the first region of the current conduction device or into the surroundings of the converter cell and is in particular constructed as a metal plate, stamped part and/or sheet-metal pressed part. This configuration offers the advantage of reduced production costs. This configuration offers the further advantage that the current conduction device is constructed in a satisfactorily mechanically stable manner for connection to a connection device not belonging to the converter cell, for example a contact rail, flexible connector or power cable.

According to a further preferred embodiment, the current conductor is constructed with a contact surface. This contact surface is essentially arranged in a peripheral surface of one of these housing parts or extends only insignificantly into the surroundings. Preferably, the contact surface is provided for electrical connection to a spring-loaded connection device. This configuration offers the advantage that the contact surface can be covered with an insulating adhesive strip for transporting or storage of the converter cell.

In the sense of the invention, a cell housing is understood as meaning an apparatus which in particular
is used for delimiting the electrode assembly with respect to the surroundings,
is used for protecting the electrode assembly from damaging influences from the surroundings, in particular for protection from water from the surroundings,
counteracts the leaking of substances from the electrode group into the surroundings,
preferably encompasses the electrode assembly in an essentially gas-tight manner.

The cell housing surrounds the electrode assembly at least in certain areas, preferably essentially completely. In this case, the cell housing is adapted to the shape of the electrode assembly. Preferably, the cell housing, just like the electrode assembly is essentially constructed to be cuboidal. The cell housing surrounds the electrode assembly preferably in such a manner that at least one wall of the cell housing exerts a force onto the electrode assembly, wherein the force counteracts an undesired relative movement of the electrode assembly with respect to the cell housing. Particularly preferably, the cell housing accommodates the electrode assembly in a positive-fitting and/or force-fitting manner. Preferably, the cell housing is electrically insulated with respect to the surroundings. Preferably, the cell housing is electrically insulated with respect to the electrode assembly.

The cell housing is constructed with at least one essentially flexurally stiff first housing part. The first housing part has at least one functional device which supports the release of energy from the electrode assembly, in particular to a consumer. The first housing part has a first support element, which supports the at least one functional device with respect to the surroundings of the converter cell. In particular, the first housing part is used for delimiting the electrode assembly with respect to the surroundings of the converter cell and also for protecting the electrode assembly. In particular, the first housing part is used for protecting the electrode assembly. Preferably, the first housing part has a wall thickness of at least 0.3 mm. Preferably, the material and the geometry of the first housing part are chosen in such a manner that the flexural stiffness thereof withstands the stresses of operation.

In the sense of the invention, a functional device is to be understood to mean a device which is in particular used to support a flawless operation of the electrode assembly. The functional device is operatively connected to the electrode assembly.

In the sense of the invention, operatively-connected functional device and electrode assembly is in particular to be understood to mean that energy, materials and/or information relating to operating parameters of the electrode assembly in particular can be exchanged between the functional device and electrode assembly. In the sense of the invention, operatively-connected functional device and electrode assembly is in particular also to be understood to mean that the functional device has the electric potential of one of the electrodes of the electrode assembly.

Preferably, the at least one functional device has at least one electrically conductive region. Preferably, the at least one functional device has at least one electrically insulating region which is particularly preferably used as a support for functional elements. The functional device is preferably in particular materially connected to the first support element. With respect to the surroundings, the functional device is essentially covered by the first support element completely as long as the first support element does not have a pole contact recess.

Preferably, the functional device is electrically connected to at least one of the electrodes, particularly preferably to at least two electrodes of different polarity. This configuration offers the advantage that the functional device has the electric potential of the connected electrode and in particular can be supplied with energy by the electrode assembly.

Preferably, the functional device is constructed as a diffusion barrier, by means of which an exchange of a gas between the surroundings of the converter cell and the interior of the cell housing is counteracted.

Preferably, the functional device is constructed as a populated and/or printed, in particular flexible circuit board. This configuration offers the advantage that the circuit board is protected by the first support element. This configuration offers the advantage that the circuit board remains on the converter cell when the converter cell is removed from a battery.

Preferably, the functional device is constructed as flame protection or fire protection. To this end, the functional device has one of these chemically reactive, flame-retardant materials and is preferably constructed as a layer or ply and is in particular constructed such that it essentially covers the adjacent electrode assembly completely. This configuration offers the advantage that the operational safety of the converter cell in the case of a fire in the region thereof is improved.

In the sense of the invention, a first support element is to be understood to mean a device which is provided to support the at least one functional device at least in certain areas. The first support element faces the surroundings of the converter cell. In the sense of the invention, “support” is to be understood to mean that an undesired relative movement of the at least one functional device with respect to the first support element or the converter cell is counteracted. The first support element is in particular used to counteract an undesired relative displacement of the at least one functional device with respect to the first support element or the converter cell. The first support element is used in particular to protect the at least one functional device from damaging influences from the surroundings of the converter cell in particular. Thus, this construction offers the advantage of protecting the electrode assembly from a foreign body acting on or even penetrating the cell housing, particularly without separate protecting devices being required.

The first support element has an in particular fibre-permeated first polymer material, preferably a thermoplastic. Preferably, the softening temperature of the polymer material is greater than the operating temperature range of the converter cell, particularly preferably by at least 10 K. Preferably, the first support element has a fibre material, in particular glass fibres, carbon fibres, basalt fibres, aramid fibres, Kevlar fibres and/or Nomex fibres, wherein the fibre material is in particular used for reinforcing the first support element. Particularly preferably, the fibre material is in particular constructed in a textile-like manner as a non-woven fabric or woven fabric and essentially surrounded by the first polymer material completely.

Preferably the at least one functional device is preferably in particular materially connected to the first support element.

Preferably, the first support element is constructed as the first support layer. This configuration offers the advantage that the at least one functional device can be supported along a relatively large area by the first support element, as a result of which the integrity of the at least one functional device is improved in particular.

Preferably, the first support element has one or two pole contact recesses, which each make a region of the adjacent functional device in particular electrically accessible from the surroundings of the converter cell.

Advantageous configurations and preferred embodiments of the converter cell according to the invention and also the advantages thereof are described in the following.

Preferably, the converter cell according to the invention has at least two electrode assemblies which are connected in series in the cell housing. This configuration offers the advantage that the nominal voltage of the converter cell is increased.

Preferably, the at least one functional device has at least one or a plurality of functional elements.

In the sense of the invention, a functional element is to be understood to mean an element which is in particular used to support a flawless operation of the electrode assembly. The functional element is used in particular
for electrically connecting the electrode assembly to the surroundings of the converter cell, and/or
for in particular electrically connecting the at least one or a plurality of these functional devices to the electrode assembly, and/or
for supplying energy in particular from the electrode assembly to the at least one or a plurality of these functional devices, and/or
for influencing or limiting the electric current which flows into the electrode assembly or is drawn from the electrode assembly, and/or
for controlling the converter cell or electrode assembly, and/or
for detecting operating parameters of the converter cell, in particular operating parameters of the electrode assembly, and/or
for exchanging heat energy with the electrode assembly, preferably heat dissipation from the electrode assembly, and/or
for supplying or draining a fluid flow of a chemical substance, and/or
for detecting the safety state of the converter cell, fault analysis, state detection or notification, and/or
for communicating with the surroundings, in particular with a battery control or with an independent control.

Preferably, at least one or a plurality of these functional elements is constructed as
a pole contact region, which is accessible from the surroundings of the converter cell, particularly through a pole contact recess of the first support element and which is in particular arranged on an external surface of the cell housing, wherein the pole contact region has the electric potential of one of the electrodes of the electrode assembly, wherein this configuration offers the advantage that at least one of these current conduction devices can be constructed without a first region,
an electrode connection region which is used for electrically connecting the functional device to the electrode assembly, which is used in particular for supplying the functional device, and which is used in particular for the electrical connection to one of the current conduction devices of the converter cell,
a voltage probe, current probe, temperature probe or thermocouple, a pressure sensor, sensor for a chemical substance, called a “substance sensor” in the following, gas sensor, liquid sensor, position sensor or acceleration sensor, wherein the sensors or probes are used in particular for detecting operating parameters of the converter cell, in particular of the electrode assembly,
a control device, in particular a cell control device, application-specific integrated circuit, microprocessor or data storage device, which are used in particular for controlling the converter cell or the electrode assembly thereof,
an adjustment device, pressure-relief device, actuator, switching device, discharge resistance, current limiter or circuit breaker, which are used in particular for carrying out adjustment measures on known, in particular undesired operating states of the converter cell, and which are used in particular for influencing or limiting the electric current into the electrode assembly or from the electrode assembly,
a conductor track which is used for electrically connecting at least two or a plurality of these functional elements to one another,
a recess which enables a connection of bodies which are spaced by means of the functional device, or which allows a body to extend through the functional device,
a heat exchange region which is used for exchanging heat energy with the electrode assembly,
a fluid duct which is used for exchanging a chemical substance with the electrode assembly, or as
a beeper, light-emitting diode, infra-red interface, GPS device, GSM module, first short-range radio device or transponder, which are used for communicating in particular with a battery control or an independent control, which are used for transmitting data in particular to a battery control or an independent control and which are used in particular for displaying an in particular predetermined operating state of the converter cell or the electrode assembly.

Preferably, the first short-range radio device is provided to intermittently transmit a predetermined second signal, in particular on request or upon a predetermined first signal from a second short-range radio device, wherein the second short-range radio device is signal-connected to a battery control. Particularly preferably, the first short-range radio device is provided to transmit an identification for the converter cell at the same time as the predetermined second signal.

Preferably, a plurality of functional elements act together for a flawless operation of the electrode assembly. Particularly preferably, these functional elements are electrically connected to one another.

A first preferred configuration of the functional device has as functional elements at least:
one of these current probes for detecting the electric current which is supplied to the electrode assembly or drawn from the electrode assembly, also called cell current in the following,
one of these voltage probes for detecting the electric voltage of the electrode assembly,
one of these thermocouples for detecting the temperature of the electrode assembly or one of these current conduction devices,
one of these cell control devices for processing signals of the in particular previously mentioned measurement probes,
one, preferably two of these electrode connection regions which are electrically connected to one, preferably two of these electrodes of in particular different polarity, and which are preferably used for supplying the cell control device and/or at least one of these measurement probes with electrical energy,
at least two or a plurality of these conductor tracks for electrically connecting the remaining functional elements of this functional device,
preferably at least one or a plurality of these switching devices, these circuit breakers and/or these current limiters,
preferably this data storage device which is used for storing and/or supplying data and/or computing rules,
preferably this first short-range radio device which is used for exchanging data with a battery control or the second short-range device thereof,
preferably two cell control connectors which are used for connecting to a data bus of a superordinate battery and which are used for exchanging data with a battery control,
preferably two heat exchange regions which are used for exchanging heat energy with the electrode assembly and a heat exchanger not belonging to the converter cell.

This preferred configuration of the functional device offers the advantage that the functional device can be used for controlling or monitoring the electrode assembly. This configuration offers the advantage that the functional device remains on the converter cell when the converter cell is removed from a battery.

According to a first preferred development of this preferred configuration, the functional device is constructed with a circuit board which is populated with these functional elements and which has conductor tracks for connecting the remaining functional elements. This preferred development offers the advantage that during the production of the first housing part, the circuit board can be supplied or placed onto this first support element with little outlay. This preferred development offers the advantage that the circuit board remains on the converter cell when the converter cell is removed from a battery.

According to a further preferred development of this preferred configuration, the functional device is constructed with a flexible film in particular made from polyimide or Kapton®, which is populated with these functional elements and which has conductor tracks for connecting the remaining functional elements. This preferred development offers the advantage that during the production of the first housing part, the functional device can be supplied or placed onto this first support element with little outlay. This preferred development offers the advantage that the functional device remains on the converter cell when the converter cell is removed from a battery.

Preferably, at least one or a plurality of these functional devices are
constructed porously at least in certain areas, particularly preferably with a foam, whereby a predetermined outer geometry of the converter cell can be achieved in particular, whereby the flexural stiffness of the first housing part is increased in particular, whereby in certain areas a volume for delaying or for accommodating a foreign body acting on the converter cell is formed in particular, and whereby a region of the first housing part with reduced thermal conductivity is formed in particular, and/or
constructed with a cavity structure, in particular with a honeycomb structure, whereby the flexural stiffness of the first housing part is increased in particular, whereby in certain areas a volume for delaying or for accommodating a foreign body acting on the converter cell is formed in particular, and whereby a region of the first housing part with reduced thermal conductivity is formed in particular, and/or
constructed with at least one cavity in particular for a tempering medium, wherein the tempering medium is used for exchanging heat energy with the electrode assembly, wherein the tempering medium flows through the cavity in particular if the temperature of the electrode assembly exceeds or falls below a limit temperature, and/or
constructed at least in certain areas with an expandable filler which is provided in particular to construct cavities when activation energy is supplied, in particular to construct cavities in a manner triggered by a functional element, and/or
constructed at least in certain areas with a filler (PCM) with the capacity for phase change in particular within the predetermined operating temperature range of the converter cell, wherein the filler intermittently exchanges heat energy in particular with the electrode assembly for the heating or cooling thereof, and/or
constructed at least in certain areas with a chemically reactive filler which is preferably provided to chemically bond a substance in particular from the electrode assembly, preferably after the release of the substance from the electrode assembly, and/or
constructed with a first layer region with a first wall thickness (thick) and a second layer region with a second wall thickness (thin), wherein the fraction made up of the second wall thickness over the first wall thickness has a predetermined value smaller than 1, preferably smaller than 0.9, preferably smaller than 0.8, preferably smaller than 0.7, preferably smaller than 0.6, preferably smaller than 0.5, preferably larger than 0.05, wherein the first layer region preferably has a lower density than the second layer region.

According to a first preferred embodiment, the expandable filler is formed by an organic aerogel with a three-dimensional structure of primary particles. These primary particles grow together without any order particularly during pyrolysis or intensive heat irradiation, wherein cavities arise between the particles. The diathermancy of the functional device is reduced by means of these cavities. This embodiment offers the advantage of an improved flame resistance of the first housing part.

According to a further preferred embodiment, the expanded filler is formed by means of expanded mica or vermiculite. Water of crystallisation is chemically bonded between the layers of the sheet structure thereof. Under the action of heat, the chemically bonded water is suddenly driven out, wherein the vermiculite is blown up to many times its volume.

Preferably, the chemically reactive filler acts in a flame-retardant manner, in particular by means of the formation of a protective layer or by interrupting a chain reaction with radicals. Preferably, the filler is selected from the following group, which includes: alum, borax, aluminium hydroxide, substances with M^{I}M^{III}(SO₄)₂ and with water of crystallisation, whereby M represents a metal ion of the oxidation stage I or III, particularly preferably potassium aluminium sulphate. According to a first preferred embodiment, the functional device is constructed as an insert impregnated with the filler, particularly preferably as a cotton ply. According to a second preferred embodiment, the functional device is pressed from a powder of the filler. This preferred embodiment offers the advantage that the protection of the electrode assembly in the case of a fire in the surroundings of the converter cell is improved.

Preferably, the converter cell or the cell housing thereof has a second housing part.

In the sense of the invention, a second housing part is to be understood to mean a device which is in particular provided to be connected at least in certain areas to the first housing part. The second housing part is provided to form the cell housing of the converter cell with the first housing part. Preferably, the first housing part and the second housing part surround the electrode assembly essentially completely and in particular counteract an exchange of substances between the electrode assembly and the surroundings of the converter cell. The second housing part has at least one first support element which essentially corresponds to the first support element of the first housing part. Preferably, the second housing part has at least one of these functional devices. Particularly preferably, the second housing part is constructed essentially identically to the first housing part. This configuration offers the advantage that production costs and warehousing are reduced.

In a first preferred embodiment of the cell housing, the first housing part and the second housing part are connected to one another via a hinged region. The hinged region extends along one edge of the first housing part and of the second housing part in each case. Preferably, the hinged region has a lower wall thickness than the regions of the housing parts which delimit the electrode assembly. This embodiment offers the advantage that the length of the edges of the in particular cuboidal cell housing to be sealed is reduced.

In a second preferred embodiment of the cell housing, the first housing part and the second housing part are spaced by means of a frame. The housing parts are in particular materially connected to the frame. The frame essentially has four frame elements which are arranged in the manner of a rectangle with respect to one another. The frame delimits a space in which the electrode assembly can be accommodated. The converter cell without functional devices with a cell housing constructed with frame has also been termed as a flat-cell frame. Preferably, the frame is constructed with the second polymer material, particularly preferably essentially completely from the second polymer material. This preferred embodiment offers the advantage that the housing parts can each be constructed without an accommodation space. According to a preferred development, two of these current conduction devices extend through the frame at least to some extent into the surroundings. According to a further preferred development, at least one of these housing parts has one or two of these pole contact regions.

Preferably, the first housing part and/or the second housing part have an accommodation space which can accommodate the electrode assembly at least to some extent.

Preferably, this accommodation space is dimensioned in such a manner that following the closing of the housing parts around the electrode assembly to form the cell housing, a friction is present between at least one inner surface of the cell housing and a peripheral surface of the electrode assembly. This friction counteracts an undesired relative movement of cell housing and electrode assembly.

According to a preferred configuration, the accommodation spaces of the first housing part and the second housing part are constructed identically. In this preferred configuration, essentially half of the electrode assembly is accommodated by one housing part in each case. This configuration offers the advantage that production costs and warehousing are reduced.

According to a further preferred configuration, the first housing part essentially accommodates the electrode assembly completely. Preferably, the first housing part is constructed as a cup. The electrode assembly is arranged in the interior of the cup, wherein the interior corresponds to the accommodation space. At least one functional device is arranged in the multi-layered wall of the cup. In this preferred configuration, the second housing part is essentially constructed for closing the first housing part as a flat lid without accommodation space and/or without functional device. This configuration offers the advantage that the second housing part can be constructed in a more cost-effective manner. According to a preferred development, two of these current conduction devices extend through the wall of the cup or through the wall of the lid at least to some extent into the surroundings. According to a further preferred development, the lid and/or the cup have two of these pole contact regions.

Preferably, the first and/or the second housing part have a second support element which is arranged between at least one of these functional devices and the electrode assembly.

In the sense of the invention, a second support element is to be understood to mean a device which is provided to stiffen the housing part. Preferably, the second support element is arranged between the at least one functional device and the electrode assembly. Preferably, the second support element is constructed as a second support layer. The second support element has an in particular fibre-permeated first polymer material, preferably a thermoplastic. Preferably, the softening temperature is greater than the operating temperature range of the converter cell, particularly preferably by at least 10 K. Further, the second support element has a fibre material, preferably glass fibres, carbon fibres, basalt fibres, aramid fibres, Kevlar fibres and/or Nomex fibres, which is in particular used for stiffening the second support element. Preferably, the fibre material is in particular constructed in a textile-like manner as a non-woven fabric or woven fabric and particularly preferably essentially surrounded by the first polymer material completely. This configuration offers the further advantage that the second support element separates the at least one functional device from the substances of the electrode assembly.

Particularly preferably, the second support element is in particular materially connected to at least one functional device. This configuration offers the advantage that the second support layer additionally stiffens or mechanically stabilises the housing part.

Particularly preferably, second housing part is in particular materially constructed in a manner corresponding to the first support element. This configuration offers the advantage of reduced manufacturing costs.

Particularly preferably, the second support element is constructed to be thinner than the first support element and in particular without fibre material. This configuration offers the advantage that the time constant is reduced when detecting the temperature of the electrode assembly and/or the cell internal pressure.

Particularly preferably, the second support element has at least one recess which allows a sensor of the functional device direct contact with the electrode assembly for detecting a substance. This configuration offers the advantage that the presence of hydrogen fluoride, in the following also called HF, is possible with a lower time constant.

Particularly preferably, the second support element in particular has at least one contacting recess in an edge region of the housing part, which is in particular used for electrically connecting the functional device adjacent to the second support element to one of the current conduction devices of the converter cell. This configuration offers the advantage that the functional device has the electric potential of one of the electrodes of the electrode assembly. This configuration offers the further advantage that the functional device can be supplied with energy by the electrode assembly.

Preferably, the first and/or second housing part has a second polymer material in an edge region. The second polymer material is used in particular for material connection to one of the other housing parts, particularly preferably for material connection of the first housing part to the second housing part. Preferably, this softening temperature of the second polymer material is greater than the operating temperature range of the converter cell, particularly preferably by at least 10 K. This configuration offers the advantage that the permanent sealing of the interior of the cell housing is improved.

Particularly preferably, the second polymer material is constructed as a thermoplastic in particular with a softening temperature above the operating temperature range of the converter cell. This configuration offers the advantage of simplified feeding of the second polymer material into a processing device, particularly into a moulding tool. This configuration offers the further advantage of an intimate, in particular gas-tight connection of the second polymer material to the respective housing part.

Particularly preferably, the second polymer material encompasses an edge region of the first and/or second housing part. This configuration offers the advantage of an intimate, in particular gas-tight connection of the second polymer material to the respective housing part.

Particularly preferably, the second polymer material corresponds to the first polymer material. This configuration offers the advantage of an intimate, in particular gas-tight connection of the second polymer material to the first polymer material.

Preferably, the converter cell, in particular the cell housing thereof, has an essentially plate-shaped third housing part.

In the sense of the invention, a third housing part is to be understood to mean a device which is in particular provided to be connected at least in certain areas to the first housing part. The third housing part is provided to be in particular materially connected at least in certain areas to the first housing part and/or to form the cell housing of the converter cell with the first housing part. The third housing part has an increased thermal conductivity compared to the first housing part. This configuration shown offers the advantage that the third housing part contributes to improved heat dissipation from the electrode assembly.

Preferably, the third housing part has a metal, particularly preferably aluminium and/or copper. This configuration shown offers the advantage that the third housing part contributes to improved heat dissipation from the electrode assembly. This preferred embodiment further offers the advantage that the protection of the electrode assembly from damaging influences from the surroundings of the converter cell is improved.

Preferably, the third housing part has a first heat transfer region, which is provided to exchange heat energy with the electrode assembly. Particularly preferably, this heat transfer region has geometries for an enlarged surface, in particular elevations, pins, cones and/or ribs, which face the surroundings of the converter cell. This configuration shown offers the advantage that the third housing part contributes to improved heat dissipation from the electrode assembly.

Preferably, the third housing part has a second heat transfer region, which is provided to exchange heat energy with a temperature control device not belonging to the converter cell. Particularly preferably, the second heat transfer region is polished. This configuration offers the advantage that the surface for thermal contacting of the temperature control device is enlarged. This configuration shown offers the advantage that the third housing part contributes to improved heat dissipation from the electrode assembly.

Preferably, the surface of the third housing facing the electrode assembly or the first housing part is coated in an electrically insulating manner. This configuration offers the advantage that the third housing part does not have an electric potential of the electrode assembly.

Preferably, the third housing part has an electrode connection region and also a pole contact region. The electrode connection region and pole contact region are electrically connected to one another. This configuration offers the advantage that the electrode assembly can be electrically contacted via the third housing part. This configuration offers the further advantage that at least one of the current conduction devices can be constructed without a first region.

Preferably, at least one or two of these current conduction devices have at least one contacting region in each case. The contacting region is used in particular for electrically connecting at least one or a plurality of these functional devices, preferably electrically supplying at least one or a plurality of these functional devices. Preferably, at least one of these contacting regions has a metal, particularly preferably aluminium and/or copper.

Preferably, the contacting region is arranged in an edge region of the first housing part, in particular in the region of the second polymer material. Preferably, the second polymer material exposes the contacting region opposite at least one of these electrode connection regions. This configuration offers the advantage that the contacting region is held by the second polymer material essentially immovably with respect to the first housing part. This configuration offers the further advantage that the second polymer material protects the electrical connection of the contacting region to the electrode connection region of the functional device from chemical loading from the surroundings of the converter cell.

Preferably, the contacting region is constructed as a protrusion which extends in the direction of the functional device in particular through one of these contacting recesses. Particularly preferably, the contacting region is constructed as a projection. This configuration offers the advantage that the connection between the current conduction device and functional device is well-suited to automation.

Preferably, the connection between the contacting region and electrode connection region is constructed materially, particularly preferably by means of a friction welding or ultrasonic welding method. This configuration offers the advantage that the connection between the current conduction device and functional device is well-suited to automation.

Preferably, the at least one of these current conduction devices has a plurality of contact lugs particularly in the second region thereof. This plurality of contact lugs are preferably materially connected to the same electrode of the electrode assembly constructed as an electrode winding, or to a plurality of electrodes of the same polarity of the electrode assembly constructed as an electrode stack. In the interior of the cell housing, the contact lugs of the same polarity are in particular materially connected to the current conductor of the same current conduction device. This current conductor also extends into the first region outside of the cell housing. Preferably, the current conductor is in particular materially connected to the first housing part in particular in the edge region thereof. Particularly preferably, the current conductor extends through the second polymer material in the edge region of the first housing part. Thus in a first manufacturing step, the current conductor is connected to the first housing part materially and in particular in a gas-tight manner and in a subsequent manufacturing step, the contact lugs are materially in particular welded to the current conductor. This configuration offers the advantage that a heat energy contribution during the first manufacturing step with the absence of the electrode assembly, does not contribute to the heating or accelerated ageing thereof.

Preferably, the at least one functional device of the converter cell or of the first housing part is arranged between the first support element and the second support element and in particular materially connected in at least certain areas to the support elements.

Preferably, the first support element has at least one or two of these pole contact recesses which make one or two of these pole contact regions of the functional device in particular electrically accessible from the surroundings.

Preferably, the second support element has at least one or two of these contacting recesses which are arranged adjacently to one or two of these electrode connection regions of the functional device. This configuration offers the advantage that an exchange of electrons with the electrode assembly is also enabled without a first region of the current conduction device extending into the surroundings.

According to a preferred development of the first housing part, the first support element has two pole contact recesses, the functional device has two pole contact regions of different polarity, the second support element has two contacting recesses and the functional device has two electrode connection regions of different polarity. This development offers the advantage that the second or third housing part can be constructed without a pole contact region, as a result of which the associated production costs in particular are reduced.

Preferably, a temperature probe or thermocouple is integrated into the second region of the current conduction device, in particular in the current conductor thereof. The supply lines for the temperature probe or thermocouple end in the edge region of the first housing part in particular at two contact surfaces in the region of a recess in the second support element. Two connectors for the functional device are also arranged in the region of this recess, and electrically connected to the contact surfaces. This configuration offers the advantage that temperature measurement is enabled in the current conduction device.

Preferably, the converter cell has a housing assembly with the first housing part and with at least one or two of these current conduction devices of different polarity. This housing assembly is used in particular for the simplified manufacture of the converter cell. The first housing part has an in particular materially-connected layer composite with the first support element, the at least one functional device and the second support element. Further, the first housing part in particular has the second polymer material in the edge region. Preferably, an edge region of the first housing part is encompassed by the second polymer material at least in certain areas. Further, the first housing part has the accommodation space which is provided to accommodate the electrode assembly at least to some extent. The at least one of these current conduction devices, in particular the current conductor thereof, has this contacting region which is arranged in the edge region of the first housing part, preferably in the second polymer material. The second support element has at least one or two of these current conduction devices, at least one or two of these contacting recesses, in the contacting region. The contacting region is in particular electrically connected to the functional device, in particular to the electrode connection region thereof, through the contacting recess. This preferred configuration offers the advantage that the housing assembly can be prepared separately.

Only after the finishing of this housing assembly is the electrode assembly inserted in the accommodation space thereof. This preferred configuration offers the further advantage that heat energy contributions during the construction of the accommodation space, during the arrangement of the second polymer material on the first housing part and/or during the in particular material connection of current conduction device and first housing part during the manufacture of this housing assembly cannot lead to the heating or to the accelerated ageing of the electrode assembly.

Preferably, at least one of these functional devices, in particular of the first housing part, has this cell control device, at least one or two of these electrode connection regions and at least one or a plurality of these measuring probes. The at least one measuring probe is provided to detect an operating parameter of the converter cell, particularly of the electrode assembly thereof and to supply the same to the cell control device.

In the sense of the invention, an operating parameter is to be understood as meaning a parameter in particular of the converter cell, which in particular
permits a conclusion as to the presence of a desired or predetermined operating state of the converter cell or the electrode assembly thereof, and/or
permits a conclusion as to the presence of an unplanned or undesired operating state of the converter cell or the electrode assembly thereof, and/or
can be determined by means of a measuring probe or sensor, wherein the measuring probe supplies a signal at least intermittently, preferably an electric voltage or an electric current, and/or
can be processed by a control device, in particular a cell control device, in particular can be compared with a target value, in particular can be linked with another detected parameter, and/or
allows information about the cell voltage, the cell current, i.e. the current intensity of the electric current into the electrode assembly or out of the electrode assembly, the cell temperature, the internal pressure of the converter cell, the integrity of the converter cell, the release of a substance from the electrode assembly, the presence of a foreign substance in particular from the surroundings of the converter cell and/or the charging state, and/or
suggests transferring the converter cell to a different operating state.

The cell control device is provided to control at least one operating method of the converter cell, in particular the charging and/or discharging of the electrode assembly. Preferably, the cell control device monitors an operating state of the converter cell. Preferably, the cell control device starts the transition of the converter cell to a predetermined operating state. Preferably, the cell control device displays the state of the converter cell by means of a display device, in particular by means of at least one LED. The preferred configuration offers the advantage that the cell control device is arranged in a protected manner in the first housing part. This preferred configuration offers the further advantage that the converter cell has a separate cell control device for operating or for monitoring the electrode assembly, which also remains on the converter cell if the converter cell is removed from a battery.

Preferably, the cell control device is provided to start the transition of the converter cell to a “safe” state, wherein the charging of the converter cell in the safe state is at most half of the nominal charging capacity, wherein in particular in the safe state, the cell voltage is 3V maximum. This preferred configuration offers the advantage that the converter cell can also be transitioned to the safe state of the converter cell outside of a battery assembly.

According to a first preferred development, the functional device has a first short-range radio device, which is signal-connected to the cell control device. This first short-range radio device is used in particular for wirelessly communicating with a superordinate battery control, in particular with the second short-range radio device thereof. Preferably, the first short-range radio device is configured to transmit a predetermined signal to a superordinate battery control in particular periodically. This development offers the advantage that the battery control can include the supplied converter cell in the predetermined signal for supplying a consumer. This development offers the further advantage that the battery control can isolate a converter cell following an absence of the predetermined signal.

According to a further preferred development, the functional device has two cell control connectors and the first support element has two recesses in the region of these cell control connectors. The converter cell can be connected to a data line or a data bus by means of the cell control connectors. This preferred development offers the advantage that the cell control can communicate with the superordinate battery control by means of the two cell control connectors.

Preferably, the converter cell has a nominal charging capacity of at least 3 ampere hours [Ah], further preferably of at least 5 Ah, further preferably of at least 10 Ah, further preferably of at least 20 Ah, further preferably of at least 50 Ah, further preferably of at least 100 Ah, further preferably of at least 200 Ah, further preferably of at most 500 Ah. This configuration offers the advantage of an improved service life of the consumer supplied by the converter cell.

Preferably, the converter cell has a nominal current of at least 50 A, further preferably of at least 100 A, further preferably of the at least 200 A, further preferably of at least 500 A, further preferably of at most 1000 A. This configuration offers the advantage of an improved performance of the consumer supplied by the converter cell.

Preferably, the converter cell has a nominal voltage of at least 1.2 V, further preferably of at least 1.5 V, further preferably of at least 2 V, further preferably of at least 2.5 V, further preferably of at least 3 V, further preferably of at least 3.5 V, further preferably of at least 4 V, further preferably of at least 4.5 V, further preferably of at least 5 V, further preferably of at least 5.5 V, further preferably of at least 6 V, further preferably of at least 6.5 V, further preferably of at least 7 V, further preferably of at most 7.5 V. Preferably, the electrode assembly has lithium ions. This configuration offers the advantage of an improved energy density of the converter cell.

Preferably, the converter cell has an operating temperature range between −40° C. and 100° C., further preferably between −20° C. and 80° C., further preferably between −10° C. and 60° C., further preferably between 0° C. and 40° C. This configuration offers the advantage of an installation or use of the converter cell for supplying a consumer, in particular a motor vehicle or a stationary system or machine, which is as free of limitation as possible.

Preferably, the converter cell has a gravimetric energy density of at least 50 Wh/kg, further preferably of at least 100 Wh/kg, further preferably of at least 200 Wh/kg, further preferably of at least 500 Wh/kg. Preferably, the electrode assembly has lithium ions. This configuration offers the advantage of an improved energy density of the converter cell.

According to a preferred embodiment, the converter cell is provided for installation into a vehicle with at least one electric motor. Preferably, the converter cell is provided to supply this electric motor. Particular preferably, the converter cell is provided to supply an electric motor of a drivetrain of a hybrid or electric vehicle at least intermittently. This configuration offers the advantage of an improved supplying of the electric motor.

According to a further preferred embodiment, the converter cell is provided for use in a stationary battery, in particular in a buffer storage unit, as a device battery, industrial battery or starter battery. Preferably, the nominal charging capacity of the converter cell for these applications is at least 50 Ah. This configuration offers the advantage of an improved supplying of a stationary consumer, in particular of a stationary mounted electric motor.

According to a first preferred embodiment, the at least one separator, which is not or only poorly electron-conductive, consists of an at least somewhat material-permeable substrate. The substrate is preferably coated on at least one side with an inorganic material. Preferably an organic material, which is preferably configured as a non-woven fleece, is used as a substrate which is at least partially permeable to material. The organic material, which preferably contains a polymer and particularly preferably a polyethylene terephthalate (PET), is coated with an inorganic, preferably ion-conducting material which is further preferably ion-conducting in a temperature range from −40° C. to 200° C. The inorganic material preferably contains at least one compound from the group of oxides, phosphates, sulphates, titanates, silicates, aluminosilicates with at least one of the elements Zr, Al, Li, particularly preferably zirconium oxide. Zirconium oxide in particular is used for substance integrity, nanoporosity and flexibility of the separator. Preferably, the inorganic ion-conducting material has particles with a largest diameter below 100 nm. This embodiment offers the advantage that the durability of the electrode assembly at temperatures above 100° C. is improved. A separator of this type is sold in Germany by Evonik AG under the brand name “Separion”, for example.

According to a second preferred embodiment, the at least one separator, which is not or only poorly electron-conductive, but is conductive for ions, consists at least overwhelmingly or completely of a ceramic, preferably of an oxide ceramic. This embodiment offers the advantage that the durability of the electrode assembly at temperatures above 100° C. is improved.

### Preferred Embodiments of the Converter Cell

A first preferred embodiment of the converter cell has a first and a second of these current conduction devices of different polarity and this cell housing on this electrode assembly. The electrode assembly is constructed as an in particular rechargeable flat electrode winding, in particular a rechargeable electrode stack or converter assembly with at least one electrode each of first and second polarity.

The current conduction devices have at least one or a plurality of these contacting lugs, wherein for each current conduction device, the at least one contact lug is electrically connected to the current conductor in the cell housing. The first current conduction device, in particular the contact lug thereof, is electrically connected to the electrode of first polarity. The second current conduction device, in particular the contact lug thereof, is electrically connected to the electrode of second polarity. Further, these current conduction devices each have one of these current conductors which preferably extend into the surroundings of the converter cell, in particular for simplified electrical connection to a connection device. The contact lugs and the current conductor of at least one of these current conduction devices are in particular materially connected.

The cell housing has the first housing part. The first housing part has the first support element, the second support element and at least one or a plurality of these functional devices in each case with at least one or a plurality of these functional elements. These support elements each have an in particular fibre-permeated first polymer material. The first support element delimits the at least one of these functional devices with respect to the surroundings of the converter cell. The second support element delimits the at least one of these functional devices with respect to the electrode assembly of the converter cell. The at least one functional device is arranged between the first and the second support element. The first support element, preferably also the second support element is in particular materially connected to at least one of these functional devices at least in certain areas. The second support element has one or two of these contacting recesses, as a result of which the adjacent functional device is exposed in certain areas with respect to the electrode assembly. In its edge region, the first housing part has the second polymer material which preferably encompasses the edge region of the first housing part. The current conductor at least of the first current conduction device is guided through the second polymer material. Preferably, the current conductor of the second current conduction device is guided through the second polymer material. Preferably, the second polymer material connects the edge region of the first housing part and the current conductor of the first current conduction device, preferably also the current conductor of the second current conduction device materially and/or in a gas-tight manner. Preferably, the first housing part has an accommodation space which accommodates the electrode assembly at least to some extent.

The at least one functional device is operatively connected, in particular electrically connected, to the electrode assembly. The at least one functional device has one, preferably two of these electrode connection regions which are used for electrically connecting to the electrode assembly. Both current conduction devices each have one of these contacting regions, wherein the contacting regions are used for electrically connecting to the at least one functional device, in particular via the electrode connection regions thereof. The first electrode connection region of the at least one functional device and the contacting region of the first current conduction device are electrically, preferably materially, connected to one another in particular in the region of the first contacting recess. Preferably, the second electrode connection region of the at least one functional device is electrically, preferably materially, connected to the contacting region of the second current conduction device in particular in the region of the second contacting recess. Preferably, the at least one functional device is constructed as a populated, in particular flexible circuit board. Particularly preferably, the functional device has this cell control device.

Further, the cell housing has a second housing part. The second housing part has at least the first support element with an in particular fibre-permeated first polymer material. Together with the first housing part, the second housing part forms the cell housing around the electrode assembly. Preferably, in an edge region, the second housing part has the second polymer material which particularly preferably encompasses the edge region of the second housing part. Preferably, the current conductor of the second current conduction device is guided through the second polymer material. Preferably, the second polymer material connects the edge region of the second housing part and the current conductor of the second current conduction device materially and/or in a gas-tight manner. Preferably, the second housing part has an accommodation space which accommodates the electrode assembly at least to some extent. Preferably, the cell housing encompasses the electrode assembly in such a manner that a friction between the cell housing and electrode assembly counteracts the undesired relative movement thereof.

This preferred embodiment offers the advantages that
the functional device is protected by the first support element from damaging influences from the surroundings of the converter cell,
damaging consequences for the functional device of vibrations from operation are counteracted,
the functional device is held essentially immovably in the cell housing,
the functional device remains on the converter cell in particular in the case of an accident,
the cell control device controls or monitors the functions of the converter cell, in particular of the electrode assembly thereof even independently of a battery control, particularly if the converter cell is not part of a battery.

According to a first preferred development of this preferred embodiment, the current conductor of the first current conduction device is guided through the second polymer material of the first housing part and the current conductor of the second current conduction device is guided through the second polymer material of the second housing part. This development offers the advantage that the production of the first and the second housing parts can take place with a few identical manufacturing steps, as a result of which the outlay in manufacturing is reduced.

According to a second preferred development of this preferred embodiment, both current conductors are guided through the second polymer material of the first housing part. Further, the accommodation space of the first housing part is dimensioned in such a manner that the electrode assembly finds space therein essentially completely. This configuration offers the advantage that the second housing part can essentially remain without an accommodation space, as a result of which the associated manufacturing outlay is reduced. This development offers the further advantage that following the insertion of the electrode assembly into the accommodation space, the electrical connections of contact lugs and current conductors can be produced in a simplified manner, in particular as a consequence of improved accessibility.

According to a third development of this preferred embodiment, the first housing part and the second housing part are connected to one another via a hinged region. The hinged region extends along one delimiting edge of the first housing part and of the second housing part in each case. Preferably, the hinged region has a lower wall thickness than the regions of the housing parts which delimit the electrode assembly. Particularly preferably, the hinged region is constructed as a film hinge. This configuration offers the advantage that the length of the edges of the cell housing to be sealed is reduced. This preferred development can be combined with the first or second preferred development.

According to a fourth development of this preferred embodiment, the first housing part and the second housing part are spaced by means of a frame. The housing parts are in particular materially connected to the frame. The frame essentially has four frame elements which are arranged in the manner of a rectangle with respect to one another. The frame delimits a space which is provided for accommodating the electrode assembly. Preferably, the frame is constructed with the second polymer material, particularly preferably essentially completely from the second polymer material. This preferred development offers the advantage that the housing parts can each be constructed without an accommodation space. According to a preferred development, two of these current conduction devices extends through the frame at least to some extent into the surroundings. According to a further preferred development, at least one of these housing parts has one or two of these pole contact regions.

A second preferred embodiment of the converter cell essentially corresponds to the first preferred embodiment, wherein the cell housing has the third housing part instead of the second housing part however.

The third housing part has an increased thermal conductivity compared to the first housing part. Preferably, the third housing part has a metal, particularly preferably aluminium and/or copper. Preferably, the third housing part is of plate-shaped construction. The third housing part has a first heat transfer region with which the electrode assembly is in thermal contact and with which the electrode assembly can exchange heat energy, in particular for cooling the electrode assembly if the temperature thereof lies above a permitted maximum temperature. Together with the first housing part, the second housing part forms the cell housing around the electrode assembly.

Preferably, both current conductors are guided through the second polymer material of the first housing part. Further, the accommodation space of the first housing part is dimensioned in such a manner that the electrode assembly finds space therein essentially completely. This embodiment offers the further advantage that following the insertion of the electrode assembly into the accommodation space, the electrical connections of contact lugs and current conductors can be produced in a simplified manner, in particular as a consequence of improved accessibility.

This preferred embodiment offers the advantages that
the functional device is protected by the first support element from damaging influences from the surroundings of the converter cell,
damaging consequences for the functional device of vibrations from operation are counteracted,
the functional device is held essentially immovably in the cell housing,
the functional device remains on the converter cell in particular in the case of an accident,
the cell control device controls or monitors the functions of the converter cell, in particular of the electrode assembly thereof even independently of a battery control, particularly if the converter cell is not part of a battery,
heat energy can be exchanged with the electrode assembly via the third housing part,
an accelerated ageing of the electrode assembly can be prevented by means of heat dissipation into the third housing part.

A third preferred embodiment of the converter cell has a first and a second of these current conduction devices of different polarity and this cell housing on this electrode assembly. The electrode assembly is constructed as a flat electrode winding or electrode stack with at least one electrode in each case of first and second polarity.

The current conduction devices each have one of these contacting regions and at least one or a plurality of these contact lugs, wherein the contacting regions are used for electrically connecting to the functional device, in particular via the electrode connection regions thereof. The first current conduction device, in particular the contact lug thereof, is electrically connected to the electrode of first polarity. The second current conduction device, in particular the contact lug thereof, is electrically connected to the electrode of second polarity.

The cell housing has the first housing part. The first housing part has the first support element, the second support element and at least one or a plurality of these functional devices in each case with at least one or a plurality of these functional elements. These support elements each have an in particular fibre-permeated first polymer material. The first support element delimits the at least one of these functional devices with respect to the surroundings of the converter cell. The second support element delimits the at least one of these functional devices with respect to the electrode assembly of the converter cell. The at least one functional device is arranged between the first and the second support element. The first support element, preferably also the second support element is in particular materially connected to at least one of these functional devices at least in certain areas. The first support element has one or two of these pole contact recesses, which each expose a region of the adjacent functional device with respect to the surroundings of the converter cell. The second support element has one or two of these contacting recesses, as a result of which the adjacent functional device is exposed in certain areas with respect to the electrode assembly. In an edge region, the first housing part has the second polymer material which encompasses the edge region of the first housing part. Also, the second polymer material connects the edge region of the first housing part to the first current conduction device, preferably also to the second current conduction device materially and/or in a gas-tight manner. The first current conduction device, preferably also the second current conduction device extends out of the second polymer material into the cell housing in the direction of the electrode assembly. Preferably, the first housing part has an accommodation space which accommodates the electrode assembly at least to some extent.

The at least one functional device is operatively connected, in particular electrically connected, to the electrode assembly. The at least one functional device has one, preferably two of these electrode connection regions which are used for electrically connecting to the electrode assembly. Both current conduction devices each have one of these contacting regions, wherein the contacting regions are used for electrically connecting to the at least one functional device, in particular via the electrode connection regions thereof. The first electrode connection region of the at least one functional device and the contacting region of the first current conduction device are electrically, preferably materially, connected to one another in particular in the region of the first contacting recess. Preferably, the second electrode connection region of the at least one functional device is electrically, preferably materially, connected to the contacting region of the second current conduction device in particular in the region of the second contacting recess. Further, the at least one functional device has one or two of these pole contact regions which are exposed with respect to the surroundings by means of one in each case of these pole contact recesses of the first support element. The pole contact regions of the at least one functional device are in each case electrically connected to the electrode connection regions thereof. Preferably, the functional device is constructed as a populated, in particular flexible circuit board. Particularly preferably, the functional device has one cell control device.

Further, the cell housing has the second housing part. The second housing part has this first support element, preferably this second support element and preferably at least one of these functional devices. The first support element, preferably also the second support element, has an in particular fibre-permeated first polymer material in each case. Preferably, the at least one functional device is arranged between the first and the second support element. Preferably, the support elements are in particular materially connected to the at least one functional device at least in certain areas. Preferably, the first support element has one of these pole contact recesses, which exposes a region of the adjacent functional device with respect to the surroundings of the converter cell. Preferably, the second support element has one of these contacting recesses, as a result of which the functional device is exposed in certain areas opposite the electrode assembly. Preferably, the functional device has one of these electrode connection regions, which is used for electrically connecting to the electrode assembly, particularly via one of these contacting regions of the current conduction devices. Preferably, the functional device has one of these pole contact regions which is exposed with respect to the surroundings through the pole contact recess of the first support element. Preferably, the pole contact region of the functional device is electrically connected to the electrode connection region thereof. In an edge region, the second housing part has the second polymer material which preferably encompasses the edge region of the second housing part. Preferably, the second polymer material connects the edge region of the second housing part and the second current conduction device materially and/or in a gas-tight manner. Preferably, the second housing part has an accommodation space which accommodates the electrode assembly at least to some extent.

This preferred embodiment offers the advantages that
the functional device is protected by the first support element from damaging influences from the surroundings of the converter cell,
damaging consequences for the functional device of vibrations from operation are counteracted,
the functional device is held essentially immovably in the cell housing,
the functional device remains on the converter cell in particular in the case of an accident,
the current conduction devices can each be constructed without a current conductor.

According to a first preferred development of this preferred embodiment, the at least one functional device of the first housing part has two of these pole contact regions and two of these electrode connection regions of different polarity in each case. The first support element of the first housing part has two of these pole contact recesses. The second support element of the first housing part has two of these contacting recesses. This preferred development offers the advantage that energy can be exchanged with the electrode assembly via the pole contact regions of the first housing part. This preferred development offers the further advantage that the current conduction devices can be constructed without a first region.

According to a second preferred development of this preferred embodiment, the at least one functional device of the first housing part has one of these pole contact regions and one of these electrode connection regions. The first support element of the first housing part has one of these pole contact recesses. The second support element of the first housing part has one of these contacting recesses. Further, the at least one functional device of the second housing part has one of these pole contact regions and one of these electrode connection regions. The first support element of the second housing part has one of these pole contact recesses. The second support element of the second housing part has one of these contacting recesses. This preferred development offers the advantage that energy can be exchanged with the electrode assembly via the pole contact regions of the first and second housing part. This preferred development offers the further advantage that the current conduction devices can be constructed without a first region.

Preferably, these housing parts are connected by means of this hinged region or by means of this frame, in accordance with the third or fourth preferred development of the first preferred embodiment of the converter cell.

A fourth preferred embodiment essentially corresponds to the first or second preferred embodiment, wherein the electrode assembly is constructed as a converter assembly. At least one of these functional devices of this preferred embodiment has at least one, preferably two or three of these fluid ducts. Connected to this fluid duct is a fluid supply line not belonging to the converter cell, which is used in particular for supplying or draining one of these process fluids. Preferably, this fluid duct is of essentially tubular construction and connected to the first support layer materially or in a gas-tight manner. Particularly preferably, this fluid duct extends out of the cell housing into the surroundings of the converter cell.

According to a first preferred development of this embodiment, the converter assembly is constructed as a polymer electrolyte fuel cell. The membrane is proton-conductive. H₂ is used as fuel and is supplied to the negative electrode, provided with a noble metal as catalyst, in particular with Pt. After ionisation, the protons migrate through the membrane to the positive electrode and there combine with the oxidising agent. Water is created as educt.

According to a second preferred development of this embodiment, the converter assembly is characterised by the integration of hydrogen reservoir and miniaturised fuel cell to form one unit. In this case, no peripheral components such as pressure reducing devices, pressure regulators and hydrogen supply lines are required. The hydrogen is supplied directly to the fuel cell from the integrated reservoir. The quantity of hydrogen supply to the fuel cell is controlled via the material properties of the surface of the hydrogen reservoir and also via the contact surface between the hydrogen reservoir and fuel cell. In order to realise the fuel cell completely without active components, it is designed as a self-breathing system. This preferred development offers great potential for miniaturisation.

According to a third preferred development of this embodiment, the converter assembly is constructed with an air cathode made up of highly porous Al₂O₃, ZnO or SiC. The anode is made up of pressed Zn powder, metal foam with embedded Zn or ceramic, in particular SiC, with Zn portions. Electrolyte and separator are constructed as a non-woven fabric or porous ceramic with 30% KOH. This preferred development is particularly suitable for high operating temperatures.

Preferably, these housing parts are connected by means of this hinged region or by means of this frame, in accordance with the third or fourth preferred development of the first preferred embodiment of the converter cell.

A fifth preferred embodiment of the converter cell essentially corresponds to the first, second or third preferred embodiment of the converter cell, wherein the first housing part and/or second housing part has two functional devices preferably constructed in a layered manner and also an insulating device, however.

The electrode assembly is designed for storing chemical energy in particular and preferably designed to be rechargeable. The electrode assembly is constructed with at least two electrodes of different polarity and as an electrode stack or electrode winding, in particular as a flat electrode winding.

The insulating device is in particular used to at least intermittently electrically insulate the first functional device with respect to the second functional device. The insulating device is constructed with an electrically insulating material, in particular with a polymer and arranged between the first functional device and the second functional device. In the following, it is described as the first state that the insulating device electrically insulates the first functional device with respect to the second functional device. In the following, it is described as the second state that the insulating device has at least in certain areas lost its suitability for electrically insulating the mentioned functional devices from one another. The second state occurs if a foreign body in particular penetrates the insulating device.

The two functional devices and also the insulating device are arranged between the first support element and the second support element. The first functional device and the second functional device are electrically conductively constructed, preferably as metal films. The first functional device is in particular connected via one of these electrode connection regions to an electrode of first polarity of the electrode assembly and the second functional device is in particular connected via one of these electrode connection regions to an electrode of second polarity of the electrode assembly. If the insulating device is intact, the electrode of first polarity is electrically insulated from the electrode of second polarity, called the first state in the following.

If a foreign body from the surroundings of the converter cell penetrates the insulating device, for example in the case of an accident, then the insulating action thereof is impaired. The insulating device is present in the second state as a consequence of the penetration. In the second state, an electrical contacting of first and second functional device can establish itself, wherein this electrical contacting is affected by an electrical resistance R_{F}. Then, an electric current I_{F} can flow between the first and the second functional devices and thus between the electrodes of different polarity. The electrical resistance R_{F} is used in particular for limiting the electric current I_{F} between the first and the second functional devices and thus between the electrodes of different polarity. The electrical resistance R_{F} is used in particular for converting a part of the energy stored in the electrode assembly into heat energy. Subsequently to this energy conversion, the energy remaining in the electrode assembly is reduced. Subsequently, the damaged converter cell can be saved with reduced energy content with minimal danger. This preferred embodiment offers the advantage of increased safety of the converter cell, even if a foreign body penetrates. Preferably, the electrical resistance R_{F} is at least 0.5Ω, further preferably at least 1Ω, further preferably at least 2Ω, further preferably at least 5Ω, further preferably at least 10Ω, further preferably at least 20Ω, further preferably at least 50Ω, further preferably at least 100Ω, further preferably at least 200Ω, further preferably at least 500Ω, further preferably at most 1000Ω. Particularly preferably, the electrical resistance R_{F} is adapted to the electric voltage of the converter cell or of the electrode assemblies thereof in such a manner that the heating output in the electrical resistance R_{F} is limited to at most 50 W, further preferably to at most 20 W, further preferably to at most 10 W, further preferably to at most 5 W, further preferably to at most 2 W further preferably to at most 1 W. This preferred development offers the advantage that impairments in particular in particular of adjacent converter cells in the same battery as a consequence of heat development are counteracted.

Preferably, the first support element and/or the second support element of the first and/or second housing part are constructed in a layered manner. Particularly preferably, at least the first support element is constructed with a fibre-permeated polymer material. This preferred configuration offers the advantage that the mechanical protection of the first functional device, which is arranged adjacently to the first support element, is improved.

Preferably, the second support element has a first and a second of these contacting recesses. Preferably, the second functional device, which is adjacent to the second support element, and the insulating device each have a recess, which recesses are adjacent to the first contacting recess. The first functional device is electrically connected through the first contacting recess to the electrode of first polarity in particular via one of these current conduction devices. The second functional device is electrically connected through the second contacting recess to the electrode of second polarity in particular via a second of these current conduction devices. Particularly preferably, the recess of the second functional device has a larger cross-sectional area than the adjacent recess of the insulating device. This preferred configuration offers the advantage of improved insulation between the first functional device and the second functional device, in particular in that a parasitic current between the first and second functional devices is counteracted.

According to a preferred embodiment, the insulating device is constructed as an insulating ply, in particular as a polymer film. This preferred embodiment offers the advantage that the insulating device can be produced in a cost-effective manner. This preferred embodiment offers the advantage that the insulating device can be constructed with a small wall thickness and thus in a space-saving manner.

According to a further preferred embodiment, the insulating device is constructed as an electrically insulating coating of the first or second functional device. This preferred configuration offers the advantage that an undesired relative movement between the electrically insulating coating and the coated support element is counteracted.

Preferably, at least one of these functional devices is realised in a puncture-resistant manner, in particular as a puncture-protection layer. To this end, this functional device has:
a woven fabric or a non-woven fabric of reinforcing fibres, in particular aramid fibres, and/or
at least one or a plurality of metallic inserts, which are preferably connected to one another, and/or
at least one or a plurality of oxide-ceramic inserts, which are preferably of plate-shaped construction.

The preferred configuration offers the advantage that this functional device opposes the foreign body with an increased mechanical resistance against the penetration thereof in particular into the electrode assembly. Particularly preferably, the functional device, which is arranged closer to the electrode assembly, is realised in a puncture-resistant manner or as a puncture protection layer. This preferred configuration offers the advantage that the mechanical protection of the electrode assembly is improved and in the process, the change of the insulating device to its second state is not impaired.

Preferably, the insulating device and/or at least one of these functional devices has a filler with the capacity for phase change in particular within a predetermined operating temperature range of the converter cell. This preferred development offers the advantage that a temperature rise as a consequence of the current through the electrically conducting foreign body is counteracted in the filler during phase change.

Preferably, the insulating device and/or at least one of these functional devices has a substance for reacting with hydrogen fluoride, particularly preferably calcium chloride. This configuration offers the advantage that hydrogen fluoride can be bound within the cell housing.

According to a preferred development, a discharge resistance R_{E} is connected between the first functional device and the at least one electrode of first polarity or between the second functional device and the at least one electrode of second polarity. Preferably, the discharge resistance is constructed as a PTC thermistor. Preferably, the electrical resistance R_{E} is at least 0.5Ω, further preferably at least 1Ω, further preferably at least 2Ω, further preferably at least 5Ω, further preferably at least 10Ω, further preferably at least 20Ω, further preferably at least 50Ω, further preferably at least 100Ω, further preferably at least 200Ω, further preferably at least 500Ω, further preferably at most 1000Ω. Particularly preferably, the electrical resistance R_{E} is adapted to the electric voltage of the converter cell or of the electrode assemblies thereof in such a manner that the heating output in the discharge resistance is limited to at most 50 W, further preferably to at most 20 W, further preferably to at most 10 W, further preferably to at most 5 W, further preferably to at most 2 W further preferably to at most 1 W. This preferred development offers the advantage that impairments in particular of adjacent converter cells in the same battery as a consequence of heat development are counteracted.

Preferably, a battery has at least two of these converter cells or the preferred embodiments thereof. Further, the battery has a battery control and preferably a second short-range radio device. Preferably, the second short-range radio device is signal-connected to one of these first short-range radio devices of one of these converter cells.

Particularly preferably, the second short-range radio device is provided to intermittently send a predetermined first signal, to which a first of these short-range radio devices responds with a predetermined signal. This configuration offers the advantage that the operating capability of converter cells of the battery can be queried using the second short-range radio device.

Particularly preferably, the battery control is provided, following the receipt of a predetermined second signal from one of these first short-range radio devices of one of the converter cells by means of the second short-range radio device, to integrate this converter cell into the supply of a connected consumer. This configuration offers the advantage that the exchange of a converter cell is simplified.

Preferably, the at least two converter cells are each constructed with one of these first and second layer regions of different wall thickness. These layer regions are adapted to one another in such a manner that at least one channel for a tempering medium is formed between the first converter cell and the second converter cell, in particular between the cell housings thereof. Particularly preferably, the channel runs between one of these first layer regions of the first converter cell and one of these second layer regions of the second converter cell. This configuration offers the advantage that the tempering medium which flows along the channel can exchange heat energy with at least one of these two converter cells, in particular for heat dissipation from at least one of these two converter cells.

### Method for Producing an Electrochemical Energy Converter Device

In the following, a method according to the invention for producing an electrochemical energy converter device, in the following also called a converter cell, is described. In particular, the converter cell is constructed as described previously. The converter cell produced in accordance with this method according to the invention has one of these electrode assemblies, at least one or two of these current conduction devices and one of these cell housings with one of these first housing parts, preferably also with one of these second or third housing parts. The electrode assembly has at least two electrodes of different polarity. At least two of these current conduction devices are connected in each case to one electrode of different polarity. Preferably, at least one or two of these current conduction devices in each case have at least one or a plurality of contact lugs, particularly preferably in each case one current conductor. Preferably, at least one or two of these current conduction devices have one contacting region in each case. The first housing part has a first support element and at least one or a plurality of these functional devices in each case with at least one or a plurality of these functional elements. The first support element faces the surroundings of the converter cell. The first support element has an in particular fibre-permeated first polymer material. The at least one functional device is in particular materially connected to the first support element at least in certain areas. At least one of these functional devices is operatively connected, preferably electrically connected, to the electrode assembly. Preferably, the first housing part has the second support element, which is arranged between the functional devices on the electrode assembly and particularly preferably is in particular materially connected to one of these functional devices. Preferably, the first housing part has a second polymer material in an edge region. The production method according to the invention is characterised by at least one of the following steps:
(S1) creating at least one or a plurality of these functional devices with at least one or a plurality of these functional elements in each case, wherein preferably at least one or two of these functional elements is constructed as an electrode connection region or as a pole contact region, preferably subsequent supply of the at least one or a plurality of these functional devices to a first supply,
(S1′) creating at least one or a plurality of these functional devices with at least one or a plurality of these functional elements in each case, wherein preferably at least one or two of these functional elements is constructed as an electrode connection region or as a pole contact region, wherein introduced into at least one of these functional devices is: a foam, a cavity structure, in particular a honeycomb structure, at least one cavity for a tempering medium, a filler with the capacity for phase change and/or a chemically reactive filler, preferably subsequent supply of at least one or a plurality of these functional devices to a first supply,
(S1″) creating at least one or a plurality of these functional devices with at least one or a plurality of these functional elements in each case, wherein preferably at least one or two of these functional elements is constructed as an electrode connection region or as a pole contact region, wherein at least one or a plurality of these functional devices is produced with a first layer region with a first wall thickness and a second layer region with a second wall thickness, wherein the fraction made up of the second wall thickness over the first wall thickness has a predetermined value smaller than 1, particularly preferably the first layer region has a lower density than the second layer region, preferably subsequent supply of at least one or a plurality of these functional devices to a first supply,
(S2) providing one of these first support elements, preferably from a second supply, which support element has an in particular fibre-permeated first polymer material, which preferably has one or two of these pole contact recesses, wherein one or two of these pole contact recesses is adjacent to one each of these pole contact regions, in particular after step S1,
(S2′) laying one of these first support elements onto another of these first support elements, in particular after step S2,
(S3) laying at least one or a plurality of these functional devices or functional assemblies, preferably from the first supply, onto the first support element, another of these functional devices or an insulating device, wherein at least one populated, in particular flexible circuit board is preferably laid onto the first support element as functional device, wherein particularly preferably the circuit board has the functional elements according to the first preferred configuration of the functional device, in particular after step S2,
(S3′) laying at least one of these insulating devices onto one of these functional devices, in particular after step S2,
(S4) in particular materially connecting the first support element to at least one of these functional devices, whereupon a layer composite is formed, preferably under the action of heat, preferably by means of an isotactic or continuous press, in particular after step S3,
(S5) laying a second support element onto one of these functional devices, preferably from a third supply, wherein the second support element has an in particular fibre-permeated first polymer material, wherein the second support element preferably has one or two contacting recesses, in particular after step S3,
(S6) connecting the second support element to one of these functional devices, in particular to the adjacent functional device, preferably under the action of heat, preferably by means of an isotactic or continuous press, in particular after step S5,
(S7) storing the layer composite in a fourth supply, in particular after step S4,
(S8) removing the layer composite in particular from the fourth supply, wherein the layer composite has at least the first support element, one or a plurality of these functional devices, with at least one or a plurality of these functional elements in each case, and preferably the second support element, in particular after step S7,
(S9) shortening at least one essentially planar moulding blank from the layer composite, preferably with a separating device, in particular after step S8,
(S10) heating the essentially planar moulding blank, preferably to a working temperature which at least corresponds to the softening temperature of the first polymer material of the first support element, in particular in the processing device, in particular after step S9,
(S11) feeding the essentially planar moulding blank into a processing device, in particular into a moulding tool, in particular after step S10,
(S12) inserting at least one or a plurality of these current conduction devices, preferably inserting at least one or a plurality of these current conductors, into the processing device, in particular into the moulding tool, in particular towards the essentially planar moulding blank, in particular after step S11,
(S13) constructing an accommodation space from the electrode assembly in the moulding blank, in particular in the processing device, in particular by means of shaping the in particular heated moulding blank with a body, wherein the accommodation space is adapted to the shape of the electrode assembly, which preferably essentially corresponds to the shape of the electrode assembly, which particularly preferably is created by closing the moulding tool, in particular after step S12,
(S14) feeding an in particular flowable second polymer material, preferably under the action of heat and preferably with a differential pressure with respect to the surrounding air pressure for the moulding blank, into the processing device, in particular into the moulding tool, wherein the second polymer material is arranged in the edge region of the moulding blank, in particular at a working temperature which at least corresponds to the softening temperature of the second polymer material, wherein preferably for each one of these contacting regions, at least one or two of these current conduction devices is exposed, in particular after one of steps S10, S11, S12 or S13,
(S15) solidifying the shaped moulding blank, preferably by means of cooling to a removal temperature, which is in particular below the softening temperature of the first polymer material, which is in particular below the softening temperature of the second polymer material, in particular after step S14,
(S16) removing the in particular shaped moulding blank, in the following also called the first housing part, from the processing device, in particular at a removal temperature, which is below the softening temperature of the first polymer material, in particular after one of steps S14 or S15,
(S17) providing the first housing part or the in particular shaped moulding blank, preferably in a processing device, which is used in particular for constructing the cell housing around the electrode assembly, in particular after step S16,
(S18) electrically, in particular materially connecting at least one or a plurality of these contact lugs to at least one or a plurality of these electrodes of the electrode assembly, in particular by means of a joining method, preferably by means of a friction welding method, particularly preferably by means of ultrasonic welding, in particular after step S17 or S19,
(S19) supplying the electrode assembly, which preferably has at least one or a plurality of these contact lugs, to the first housing part preferably into the processing device, in particular inserting the electrode assembly into the accommodation space of the first housing part, in particular after step S17,
(S20) electrically connecting the electrode assembly to at least one or a plurality of these current conduction devices, in particular by means of a joining method, preferably by means of a friction welding method, particularly preferably by means of ultrasonic welding, in particular after step S19,
(S21) electrically connecting at least one or a plurality of these contact lugs to one of these current conductors which belong to the same current conduction device, in particular by means of a joining method, preferably by means of a friction welding method, particularly preferably by means of ultrasonic welding, in particular after step S19,
(S22) electrically connecting the contacting region at least of one or a plurality of these current conduction devices to at least one or a plurality of these electrode connection regions of at least one of these functional devices of the first housing part, in particular in the region of one of these contacting recesses of the second support element of the first housing part, in particular by means of a joining method, preferably by means of a friction welding method, particularly preferably by means of ultrasonic welding, in particular after step S11, in particular before step S26,
(S23) supplying the second housing part to the first housing part, wherein the second housing part preferably has the second polymer material in an edge region, in particular after step S22,
(S24) supplying the third housing part to the first housing part, wherein a first heat transfer region of the third housing part is preferably arranged adjacently to the electrode assembly, particularly preferably is brought into thermal contact with the electrode assembly, in particular after step S22,
(S25) heating in particular of the edge region of the in particular first housing part to a working temperature, which preferably at least corresponds to the softening temperature of the second polymer material,
(S26) in particular materially connecting the second housing part or the third housing part to the first housing part, in particular at a working temperature which at least corresponds to the softening temperature of the second polymer material, wherein an edge region of the first housing part is preferably connected to the second housing part or the third housing part, in particular after step S25,
(S26′) in particular materially connecting the second housing part or the third housing part to the first housing part, in particular with the use of a sealant and/or adhesive, wherein an edge region of the first housing part is preferably connected to the second housing part or the third housing part, in particular after step S25,
(S26″) in particular materially connecting the second housing part or the third housing part to the first housing part, preferably whilst feeding an in particular flowable second polymer material, preferably under the action of heat and at a differential pressure with respect to the surroundings of the processing device, in particular into the moulding tool, wherein the second polymer material is arranged in the edge region of the at least one of the housing parts, in particular at a temperature which at least corresponds to the softening temperature of the second polymer material, wherein preferably for each one of these contacting regions at least one or two of these current conduction devices is exposed, wherein preferably an edge region of the first housing part is connected to the second housing part or the third housing part, in particular after step S25,
(S27) combining a plurality of these functional elements to form one of these functional devices, as a result of which in particular one functional assembly is formed, in particular before step S3,
(S28) lowering the air pressure in the surroundings of the first housing part, in particular before step S26, whereupon the higher normal pressure in the surroundings of the cell housing closed after step S26 effects a friction between the cell housing and electrode assembly, which counteracts an undesired relative movement of cell housing and electrode assembly,
(S29) creating one of these insulating devices, preferably as an insulating ply, preferably with a recess.

In the sense of the invention, a differential pressure with respect to the surroundings of the processing device in step S26″ is to be understood to mean that the second polymer material has a higher static pressure when fed into the processing device than the static pressure in the processing device. According to a preferred configuration of the step S26″, the second polymer material is loaded with an overpressure with respect to the surroundings of the processing device. According to a further preferred configuration of step S26″, an underpressure with respect to the surroundings of the processing device is present in the region of the housing parts inserted into the processing device. Both pressure differences are used for feeding the second polymer material into the processing device. Both configurations offer the advantage that the filling of regions of the processing device provided for the second polymer material is improved during the connection of the inserted housing parts.

The production method according to the invention offers the advantage that the cell housing or the first housing part thereof can be produced with a predetermined flexural stiffness and/or a predetermined capacity for energy absorption with respect to a foreign body acting on the converter cell from the surroundings, as a result of which the mechanical resistance of the converter cell in particular is improved. Preferably, to this end step S2 is executed multiple times before step S4, whereupon a plurality of first support elements are connected to the functional device to form a layer composite or moulding blank.

The production method according to the invention offers the advantage that the cell housing or the first housing part thereof, which within the operating temperature range has a predetermined flexural stiffness and/or a predetermined capacity for energy absorption with respect to a foreign body acting on the converter cell from the surroundings, can be produced at the working temperature with low energy outlay.

The production method according to the invention offers the advantage that the first support element improves the cohesion of the functional device, as a result of which the resistance of the converter cell with respect to vibrations or the operating capability of the converter cell in the case of vibrations is improved.

The production method according to the invention offers the advantage that in particular in contrast with converter cells with a film-like cell housing, it is possible to dispense with reinforcing components.

The production method according to the invention offers the advantage that after the construction of the functional device, the layer composite and/or the first housing part, the later manufacturing steps are simplified. Thus, production costs are saved. The production method according to the invention offers the further advantage that output and quality of production are improved.

The production method according to the invention offers the advantage that the cell housing can be adapted simply and in a cost-effective manner to the electrode assemblies of different nominal charging capacities, in particular in that the accommodation space in the first housing part can be produced just directly before the insertion of the electrode assembly. Thus, storage costs can be reduced.

### Preferred Configuration is of the Previously Mentioned Method According to the Invention for Producing a Converter Cell

A first preferred configuration of the previously mentioned method according to the invention for producing a converter cell, in particular for closing the cell housing around the electrode assembly, is characterised by the steps:
S17, S19, S20, S23 and S26, wherein the cell housing has one of these second housing parts, or
S17, S19, S20, S24 and S26, wherein the cell housing has one of these third housing parts.

This preferred configuration of the method offers the advantage that at least one or a plurality of these functional devices of the first housing part are arranged within the cell housing in particular in a protected manner.

Preferably, the method also has step S25. This preferred configuration offers the advantage that the material connection of the heated edge region with the second polymer material is improved.

Preferably, step S26 is replaced by step S26′. This preferred configuration offers the advantage that connecting this housing part can take place at a temperature below the softening temperature of the first or second polymer material, particularly preferably at room temperature, as a result of which energy can be saved.

Preferably, step S26 is replaced by step S26″. This preferred configuration offers the advantage that the filling of regions of the processing device provided for the second polymer material is improved during the connection of the inserted housing parts.

A second preferred configuration of the previously mentioned method according to the invention for producing a converter cell, in particular for producing the first housing part, is characterised by the steps: S11, S12, S14, S15, S16. Preferably, this configuration of the method has step S10 for heating the moulding blank. Preferably, this configuration of the method has step S13 for constructing the accommodation space. This preferred configuration of the method offers the advantage that at least one or a plurality of these current conduction devices is encompassed by the second polymer material in particular in a gas-tight manner, whereby in particular an exchange of substances between the interior of the cell housing and the surroundings of the converter cell is counteracted.

A third preferred configuration of the previously mentioned method according to the invention for producing a converter cell, in particular for producing a layer composite, wherein the layer composite has the first support element, at least one or a plurality of these functional devices and preferably the second support element, is characterised by the steps: S2, S3, S4. This preferred configuration of the method offers the advantage that an in particular material connection between the first support element and at least one of these functional devices is created, as a result of which the cohesion of this functional device is improved in particular in the case of bumps. Preferably, in step S3 at least one populated, in particular flexible circuit board is laid onto the first support element is functional device or functional assembly. In this case, this circuit board has the functional elements according to the first preferred configuration of the functional device. This preferred configuration of the method offers the advantage that numerous functions for controlling or monitoring the electrode assembly can be realised in the functional device, which is connected to the first support element or in particular is a captive part of the cell housing.

Preferably, this configuration of the method in particular after step S2, also has the step S2′. In this case, two first support layers are laid on one another. This preferred configuration offers the advantage that the wall thickness of the layer composite is increased, whereby an improved mechanical protection of an adjacent functional device is achieved.

Preferably, this configuration of the method also has the steps S5 and S6. Particularly preferably, step S5 takes place before the simultaneously executed steps S4 and S6. This preferred configuration offers the advantage that the housing part is stiffened using at least one of these second support elements. This preferred configuration offers the advantage that this functional device is electrically insulated with respect to the electrode assembly by means of this second support element.

Preferably, this configuration of the method also has one of the steps S1, S1′ or S1″, in particular before step S2, particularly preferably with step S27. This preferred configuration offers the advantage that the directly preceding creation also saves the functional device storage costs.

According to a preferred development of this preferred configuration, the layer composite is produced with different wall thicknesses. In this case, regions for the first housing part, the second housing part and for a hinged region are produced. The hinged region is produced with a lower wall thickness than the regions for the housing parts and preferably without a functional device, preferably in that the regions for the housing parts receive additional support layers or the hinged region only has one of these first support layers. The hinged region is arranged between the region for the first housing part and the region for the second housing part. Later, the moulding blank is shortened in such a manner that it at one first end has this region for the first housing, at an opposite end has this region for the second housing and in-between has the hinged region. This development offers the advantage that the length of the edges of the in particular cuboidal cell housing to be sealed is reduced.

To close the cell housing or when connecting the first housing part to the second housing part, the hinged region is brought to a working temperature above the softening temperature of the first polymer material and bent over in such a manner that the region for the first housing part lies opposite the region for the second housing part. Subsequently, in particular after the connection of the housing parts around the electrode assembly, the hinged region is brought to a removal temperature, in particular below the softening temperature of the first polymer material.

A fourth preferred configuration of the previously mentioned method according to the invention for producing a converter cell, in particular for producing the first preferred development of the first preferred embodiment of the converter cell, is characterised by the steps:
S11, wherein one of these moulding blanks is supplied with one of these functional devices to a processing device, wherein this functional device has at least one of these electrode connection regions,
S12, wherein one or preferably two of these current conduction devices or the current conductors thereof are passed into the moulding tool to this moulding blank and with their arranged in the edge region of the moulding blank or of the future first housing part,
preferably S22, wherein at least one of these contacting regions of one of these current conduction devices or of one of these current conductors is electrically connected to at least one of these electrode connection regions of the functional device,
S10, S13 and S14, wherein preferably S10 is executed temporally before S13 and preferably S13 is executed simultaneously with S14, whereupon the moulding blank receives an accommodation space for the electrode assembly and second polymer material is arranged in the edge region of the moulding blank in such a manner that the inserted current conduction devices or the current conductors thereof are encompassed by the second polymer material in particular in a gas-tight manner,
S15, whereupon the softened first polymer material of the first support element becomes solid again and the resulting first housing part can be removed from the moulding tool,
S18, for equipping the electrode assembly with at least one or a plurality of these contact lugs, wherein the contact lugs are connected to at least one of these electrodes of first polarity or to at least this of the electrodes of second polarity,
S17 and S19, whereby the electrode assembly is supplied to the first housing part provided in the processing device, preferably is arranged in the accommodation space of the first housing part,
S21, wherein these contact lugs which are connected to these electrodes of first polarity, and these contact lugs which are connected to these electrodes of second polarity, are electrically connected to various current conductors, in particular by means of a joining method,
S23, wherein the second housing part is inserted into the processing device towards the first housing part and towards the electrode assembly, wherein at least one of these edge regions of the first housing part and at least one of these edge regions of the second housing part are arranged adjacently to one another.
preferably S25, wherein the edge region in particular of the in particular first housing part is heated to a working temperature, which preferably at least corresponds to the softening temperature of the second polymer material,
S26, wherein the edge regions in particular, preferably the second polymer materials of the first housing part and of the second housing part are in particular materially connected to one another, in particular at a working temperature which at least corresponds to the softening temperature of the second polymer material.

A fifth preferred configuration of the previously mentioned method according to the invention is used for producing a converter cell, in particular for producing the previously mentioned fifth preferred embodiment of the converter cell, in particular for producing one of these first and/or second housing parts with two of these functional devices and the insulating device.

The first and/or second housing parts each have the first support element and the second support element, wherein the two functional devices and the insulating device are arranged between these support elements. The first and the second functional devices are constructed as electrical conductors, preferably as metal films, and each with one of these electrode connection regions. The first functional device is arranged adjacently to the first support element. The insulating device is constructed as an insulating ply and has a recess adjacent to the electrode connection of the first functional device. The second functional device has one of these recesses adjacent to the recess of the insulating ply. The second support element, which is arranged adjacently to the second functional device, has one each of these contacting recesses adjacent to the electrode connection regions of the first and second functional devices.

The method is characterised by the steps:
S1, the step is executed multiple times, wherein initially the first functional device is constructed at least with one of these electrode connection regions, subsequently the second functional device is constructed at least with one of these electrode connection regions and with this recess,
S29, creating one of these insulating devices, preferably as an insulating ply, preferably with a recess,
S2,
S3, this step is executed multiple times, wherein initially the first functional device is laid onto the first support element, later the second functional device is laid onto the insulating device,
S3′, wherein the insulating device is laid onto the first functional device,
preferably S4, whereby this layer composite is formed,
S5,
preferably S6, whereby the second support element is supplied to this layer composite.

During the steps S3 and step S3′, which are executed multiple times, the recesses of the insulating device and the second functional device and also the contacting recesses of the second support element are arranged in such a manner that the electrode connection regions of the first and second functional devices are exposed opposite the current conduction devices through the recesses and contacting recesses mentioned.

After these steps, a layer composite with the first support element, these two functional devices, this insulating device and the second support element is formed. Preferably, the layer composite is supplied to the fourth supply in accordance with step S7.

Subsequently, the steps S11, S12, S14, S15, S16 are carried out. Preferably, step S13 for constructing the accommodation space is executed. Particularly preferably, step S10 for heating the moulding blank or for softening the first polymer material is executed, whereby the construction of the accommodation space is simplified in the case of softened first polymer material. Thus, a housing part is created for a preferred embodiment, in particular for the preferred fifth embodiment with three functional devices and with two of these current conductors (S11) of different polarity, which are encompassed by the second polymer material (S13) in particular in a gas-tight manner.

Subsequently, the following steps are executed:
preferably S18, for equipping the electrode assembly with at least one or a plurality of these contact lugs, wherein the contact lugs are connected to at least one of these electrodes of first polarity or to at least this of the electrodes of second polarity,
S17 and S19, whereby the electrode assembly is supplied to the first housing part provided in the processing device, preferably is arranged in the accommodation space of the first housing part,
S21, wherein these contact lugs which are connected to these electrodes of first polarity, and these contact lugs which are connected to these electrodes of second polarity, are electrically connected to various current conductors, in particular by means of a joining method,
S22, wherein one of these electrode connection regions is electrically connected to one of these current conductors of first polarity, in particular to the contacting region thereof, wherein another of these electrode connection regions is electrically connected to one of these current conductors of second polarity, in particular to the contacting region thereof.
S23, wherein the second housing part is inserted into the processing device towards the first housing part and towards the electrode assembly, wherein at least one of these edge regions of the first housing part and at least one of these edge regions of the second housing part are arranged adjacently to one another.
S26, wherein the edge regions in particular, preferably the second polymer materials of the first housing part and of the second housing part are in particular materially connected to one another, in particular at a working temperature which at least corresponds to the softening temperature of the second polymer material.

As a result of this preferred production method, a converter cell is created which has the advantage of an increased operational reliability.

If a foreign body from the surroundings of the converter cell penetrates the insulating device, for example in the case of an accident, then the insulating action thereof is impaired. As a consequence of the penetration of the insulating device, an electrical contacting of first and second functional device can establish itself, in particular with an electrical resistance R_{F}. In this state of the insulating device, called the second state in the following, the first functional device and the second functional device can be electrically connected to one another. Then, an electric current I_{F} can flow between the first and the second functional devices and thus between the electrodes of different polarity. The electrical resistance R_{F} is used in particular for limiting the electric current I_{F}. The electrical resistance R_{F} is used in particular for converting a part of the energy stored in the electrode assembly into heat energy. Subsequently to this energy conversion, the energy remaining in the electrode assembly is reduced. Subsequently, the damaged converter cell can be saved with reduced energy content with minimal danger. This preferred embodiment offers the advantage of increased safety of the converter cell, even if a foreign body penetrates.

Further advantages, features and application possibilities of the present invention result from the following description in connection with the figures. In the figures:

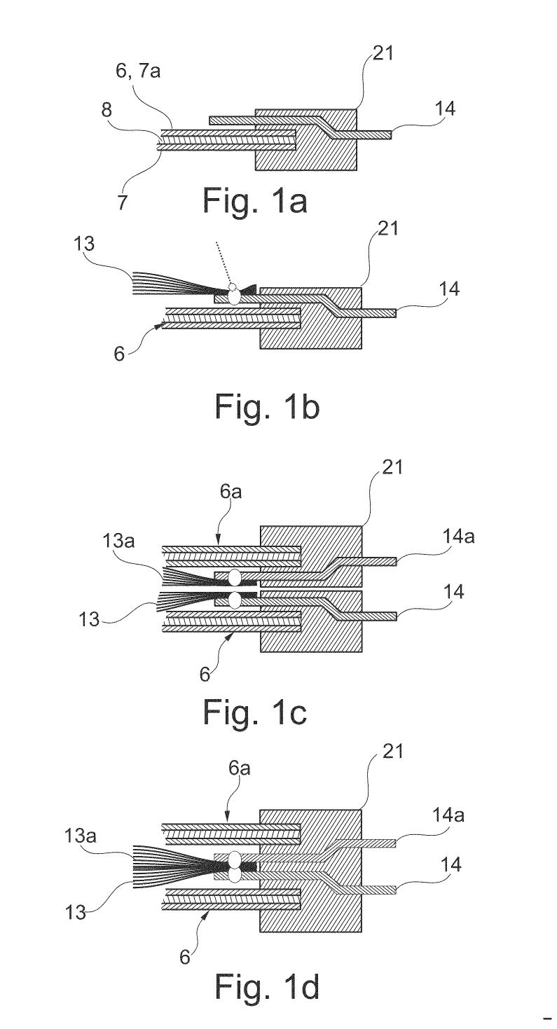

FIG. 1 schematically shows details of a preferred embodiment of an electrochemical energy converter device according to the invention,

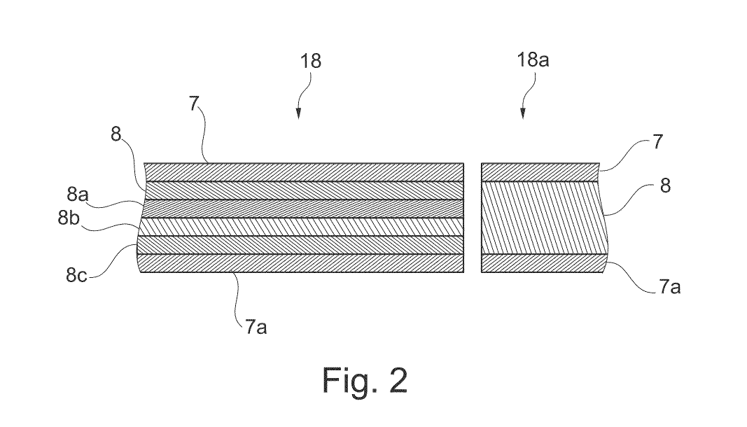

FIG. 2 schematically shows two different layer composites for first housing parts,

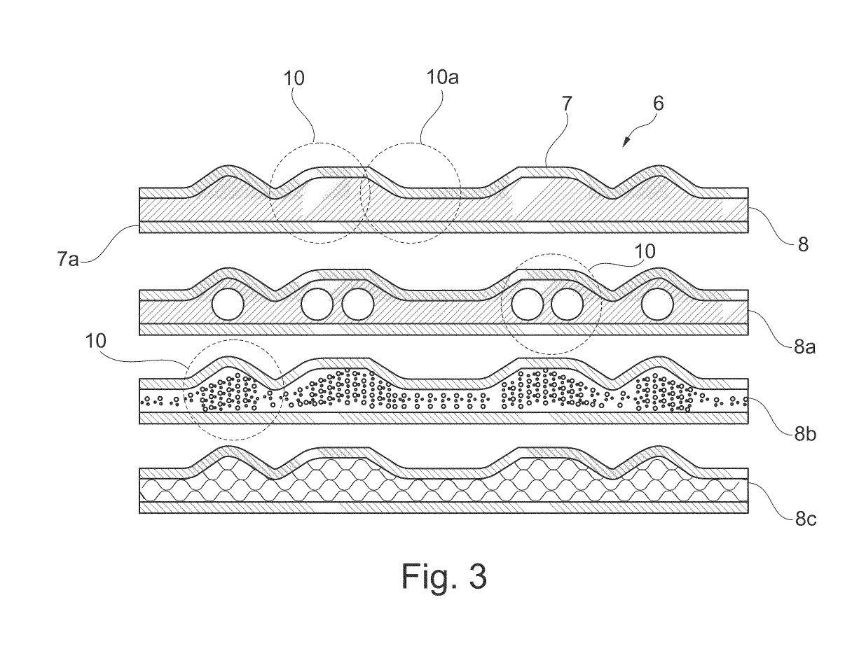

FIG. 3 shows schematic sections through first housing parts with various functional elements or first and second layer regions,

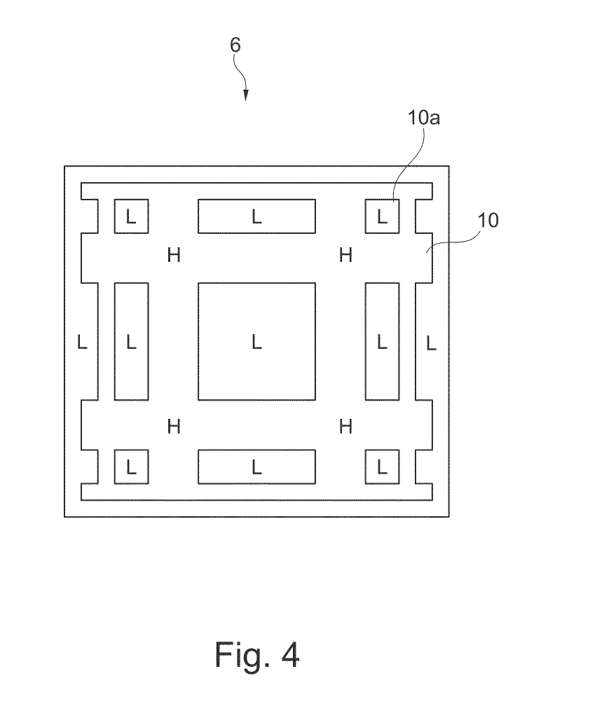

FIG. 4 shows a schematic view of a first housing part with first and second layer regions,

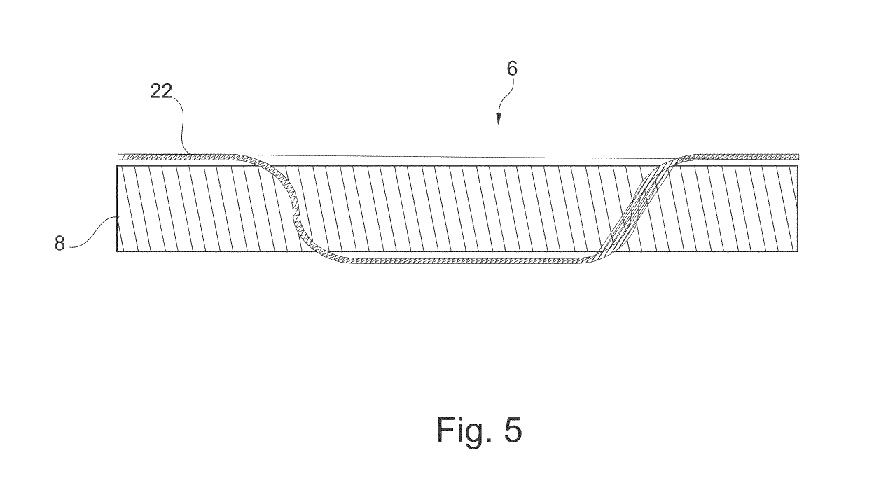

FIG. 5 schematically shows a section through a first housing part with a metallic insert,

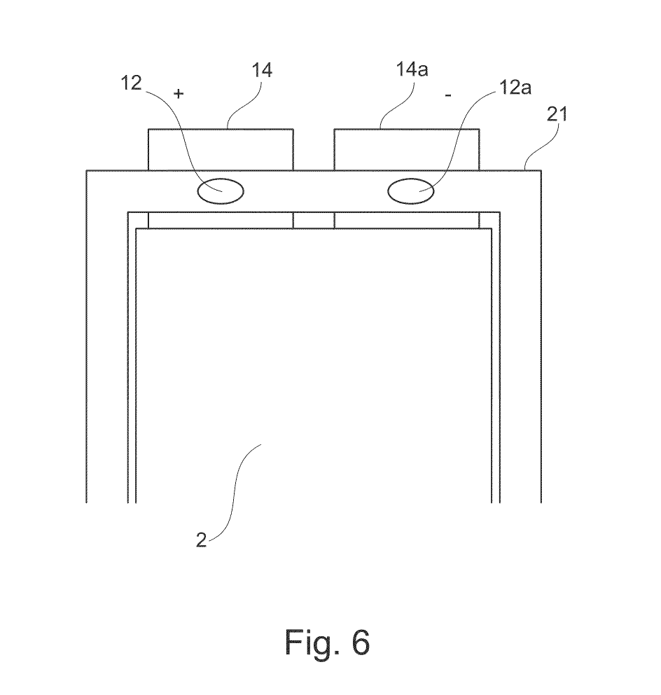

FIG. 6 shows a schematic section through a preferred embodiment of a converter cell,

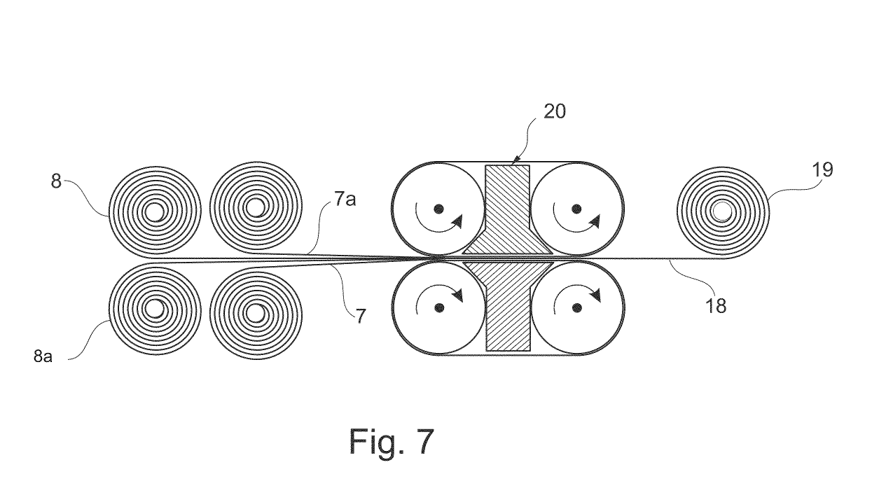

FIG. 7 schematically shows a processing device for producing a layer composite for a first housing part,

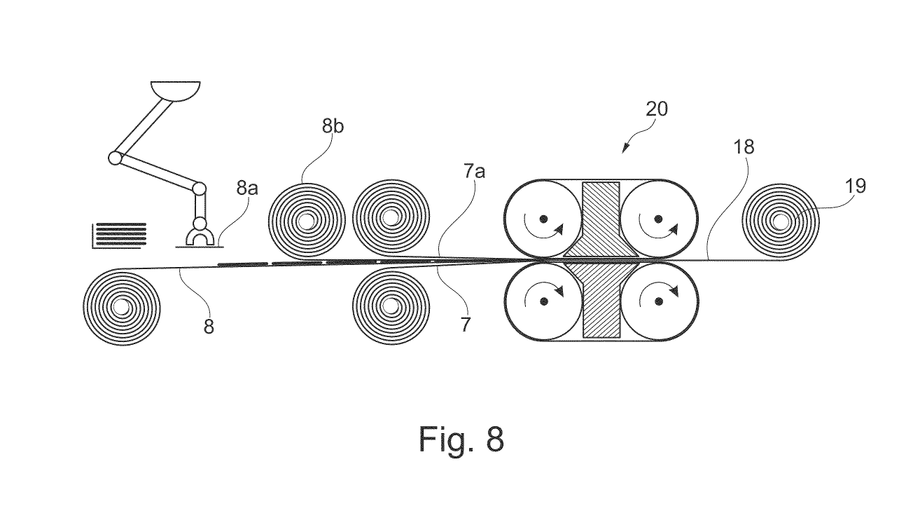

FIG. 8 schematically shows a processing device for producing a layer composite for a certain embodiment of a first housing part, wherein one of these functional devices is constructed as a populated flexible circuit board,

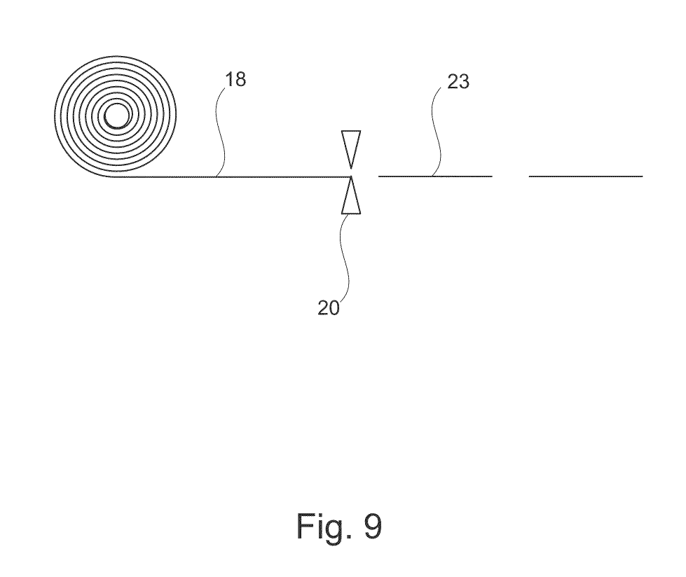

FIG. 9 schematically shows the shortening of moulding blanks of a prepared layer composite,

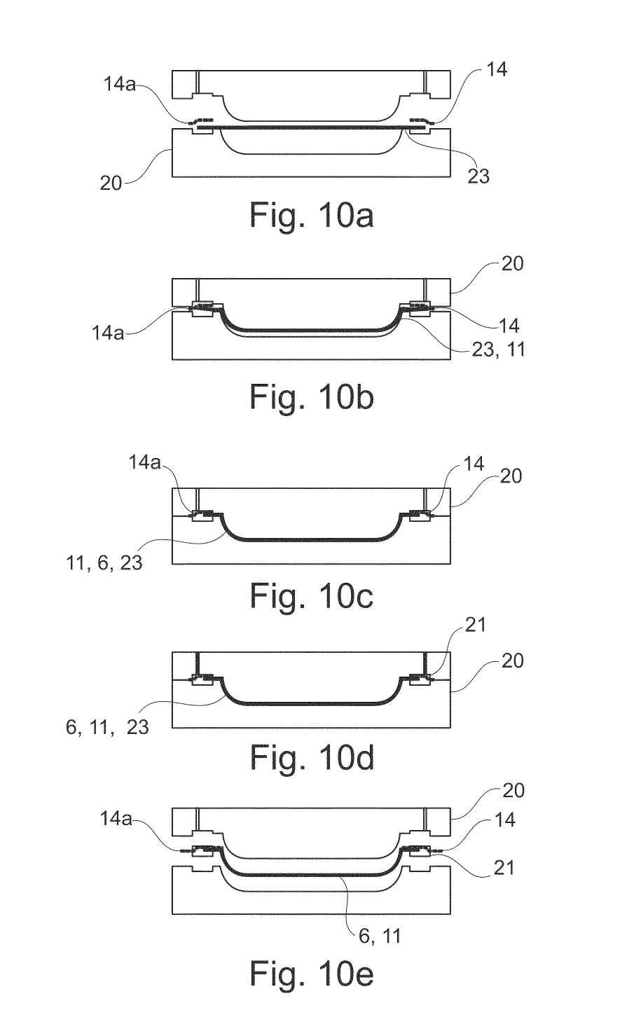

FIG. 10 schematically shows the production of a first housing part from a moulding blank with supplying a second polymer material in the edge region, with constructing an accommodation space for an electrode assembly, with overmoulding of current conductors and of the edge region of the moulding blank, in a processing device,

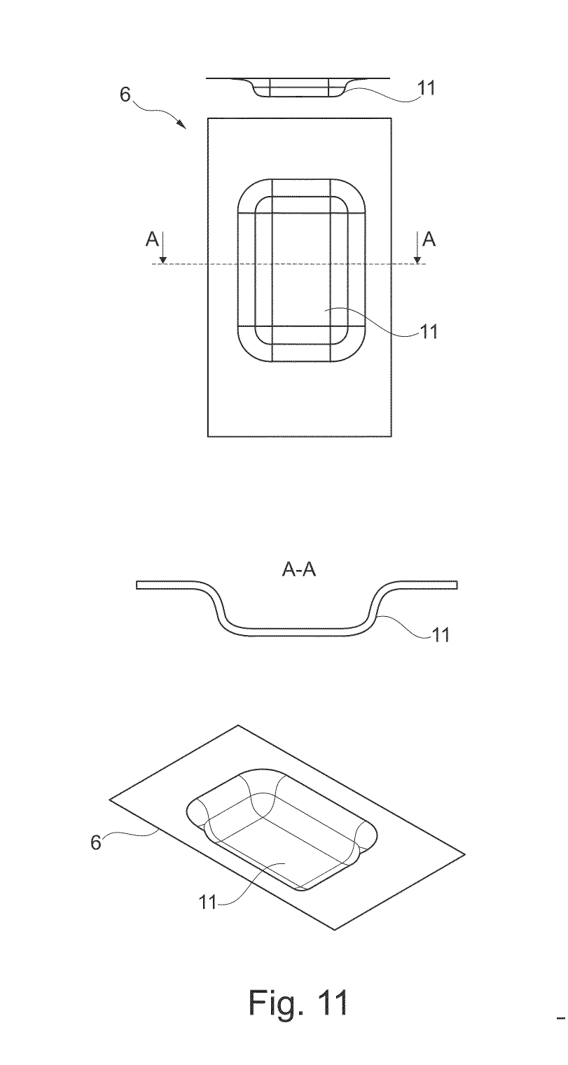

FIG. 11 shows various views and sections of a first housing part with accommodation space,

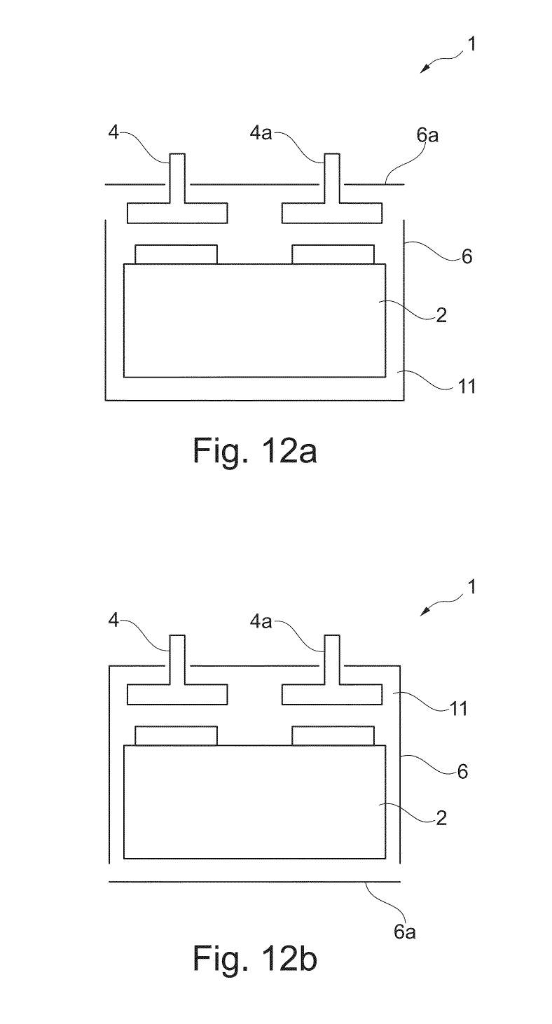

FIG. 12 schematically shows a converter cell with a two-part cell housing, wherein the first housing part is constructed as a cup and the second housing part is constructed as a lid,

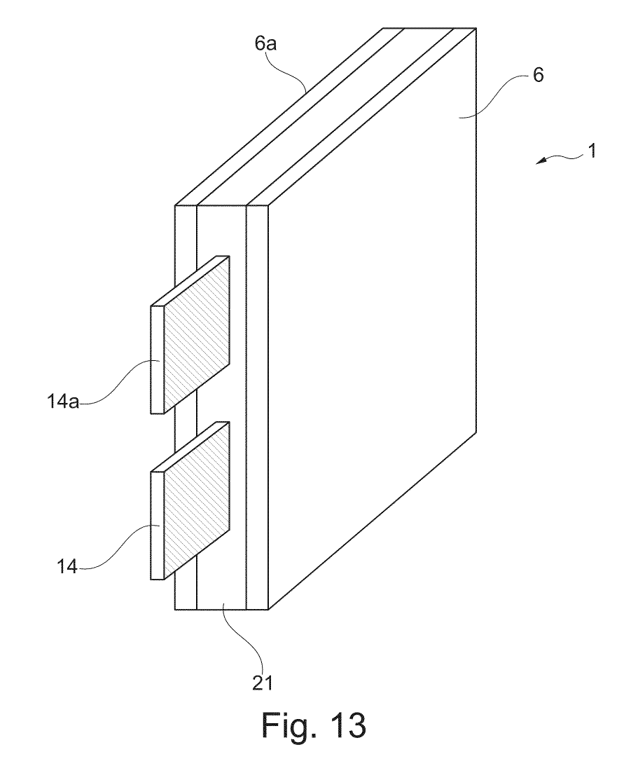

FIG. 13 schematically shows a converter cell with a two-part cell housing, wherein the housing parts are spaced by means of a frame made up of the second polymer material

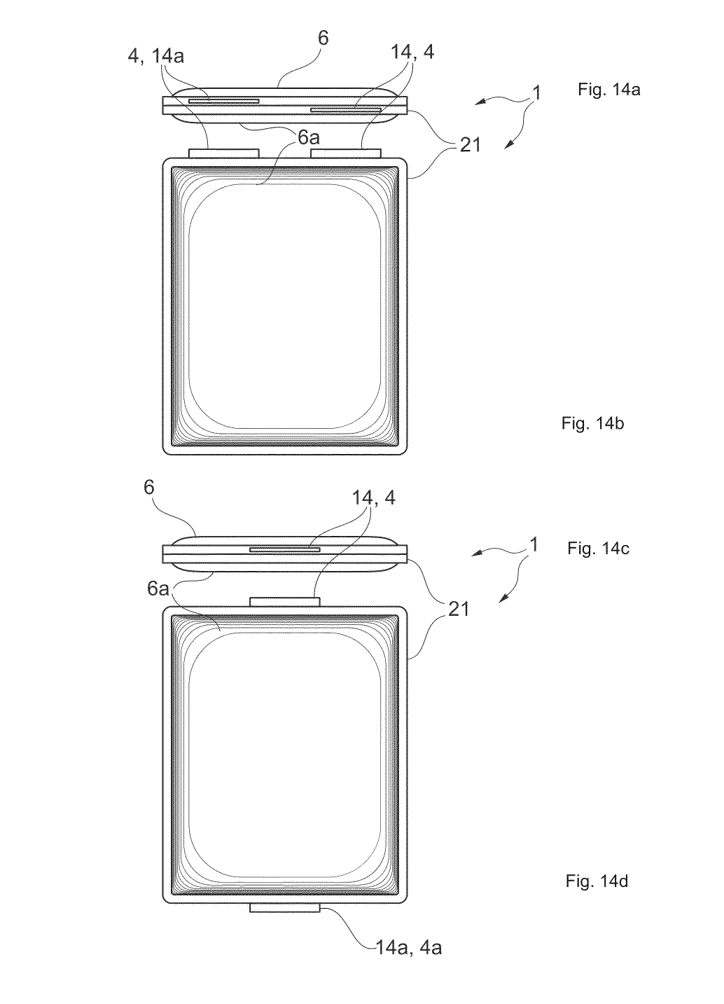

FIG. 14 schematically shows further preferred embodiments of converter cells in each case with a two-part cell housing and each with two current conductors which extend into the surroundings of the converter cell,

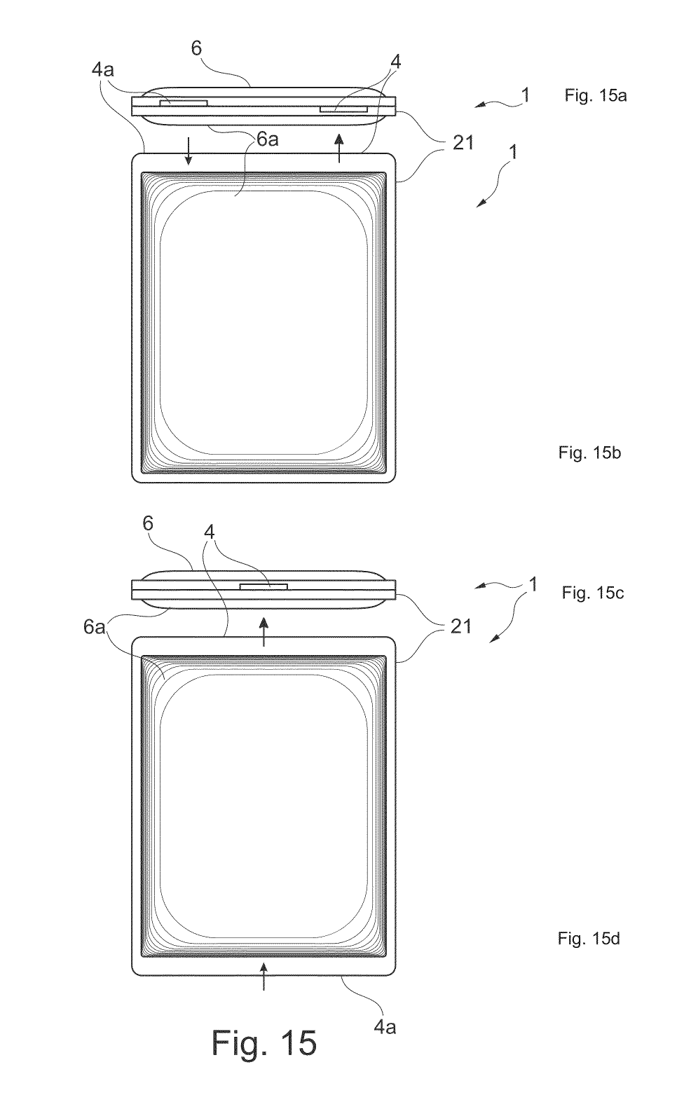

FIG. 15 schematically shows further preferred embodiments of converter cells in each case with a two-part cell housing and with current conduction devices which essentially each terminate with a peripheral surface of the cell housing,

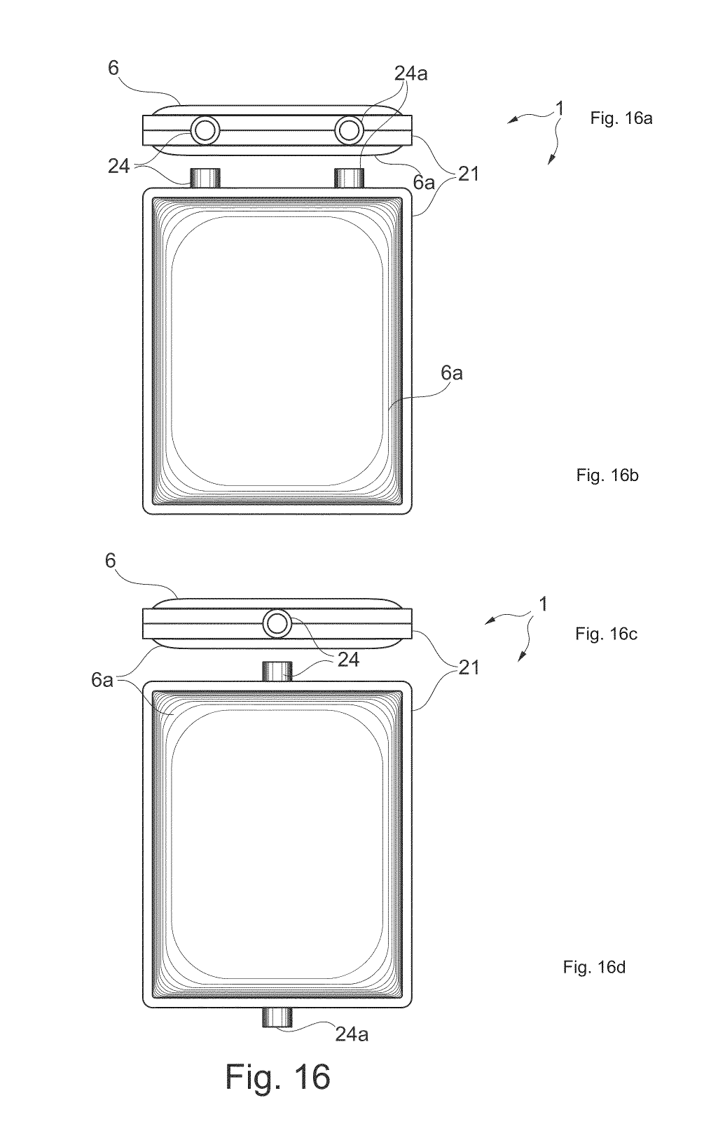

FIG. 16 schematically shows further preferred embodiments of converter cells in each case with a two-part cell housing each with a converter assembly and two fluid ducts

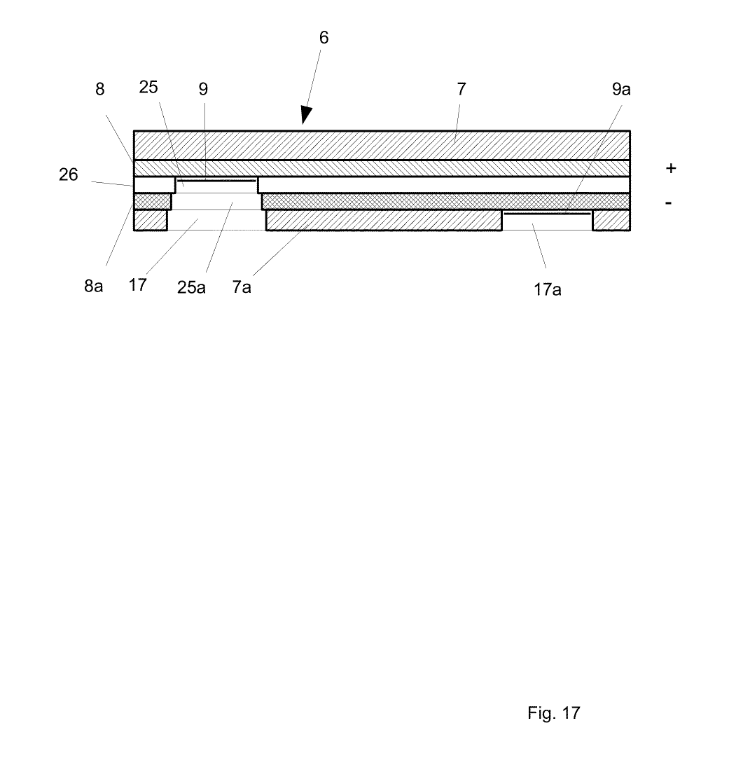

FIG. 17 schematically shows a section through a first housing part with two functional devices and with one insulating device.

FIG. 1 schematically shows details of a preferred embodiment of an electrochemical energy converter device according to the invention or converter cell 1 with a first housing part 6. Advantageously, the first support element 7 and the second support element 7a are constructed as support layers.

FIG. 1a shows that the first housing part 6 is overmoulded in an edge region with a second polymer material 21. A current conductor 14 is overmoulded by the second polymer material 21 in particular in a gas-tight manner and essentially immovably connected to the first housing part 6. The first housing part 6 has the first support element 7, the second support element 7a and a functional device 8, wherein the functional device 8 spaces the support elements 7, 7a.

FIG. 1b shows that contact lugs 13 are welded to the current conductor 14. The contact lugs 13 are also electrically, in particular materially connected to electrodes of first polarity of an electrode assembly which is not illustrated. This electrical connection has been created after the electrode assembly, which is not illustrated, has been inserted into the first housing part 6 and before the cell housing is closed.

FIG. 1c shows the first housing part 6 and a second housing part 6a, the edge regions of which are in each case overmoulded with the second polymer material 21. In each case, the current conductor 14, 14a is connected to one of the housing parts 6, 6a through second polymer materials 21. Groups of contact lugs 13, 13a are welded to the current conductors 14, 14a. These groups of contact lugs 13, 13a are electrically connected to electrodes of different polarity of the same electrode assembly which is not illustrated. Thus, the first current conductor 14 has a different polarity to the second current conductor 14a. The cell housing is not yet closed.

FIG. 1d schematically shows a detail of the converter cell 1 after the cell housing 5 has been closed by means of materially connecting the first housing part 6 to the second housing part 6a. In this case, second polymer materials 21 of the edge regions of the housing parts 6, 6a were fused with one another. The current conductors 14, 14a extend out of the cell housing 5. The current conductors 14, 14a also extend in the cell housing 5.

FIG. 2 schematically shows to different layer composites 18, 18a for a first housing part. Advantageously, the first support element 7 and the second support element 7a are constructed as support layers.

The layer composite 18 has two support elements 7, 7a which surround or encompass four functional devices 8, 8a, 8b, 8c. The individual functional devices fulfil various tasks and to this end have various functional elements. The second support element 7a has an arrangement of recesses or holes which enable a substance to pass in particular from the electrode assembly, which is not illustrated, to the fourth functional device 8c. The fourth functional device 8c has a pressure sensor, a thermocouple and a sensor for hydrogen fluoride, wherein the sensors are not illustrated. The third functional device 8b chemically and electrically insulates the second functional device 8a from the electrode assembly. The third functional device 8b has functional elements for signal exchange between the second functional device 8a and the sensors mentioned, however. The second functional device 8a has a cell control device, which is not illustrated and which processes signals of the sensors mentioned and controls the operation of the likewise not-illustrated electrode assembly. The first functional device 8 is a cotton ply with alum as flame-retardant filler and is used for protecting the second functional device 8a lying therebeneath.

The layer composite 18a has only one functional device 8. Here, the pressure sensor, the thermocouple and the cell control device are part of the same functional device 8.

FIG. 3 shows schematic sections through various configurations of the first housing part 6 with various functional devices 8, 8a, 8b, 8c and also first and second layer regions 10, 10a. The functional device 8 is encompassed by the first support element 7 and the second support element 7a. Advantageously, the first support element 7 and the second support element 7a are constructed as support layers. The functional device 8 has two layer regions 10, 10a, wherein the first layer region 10 has a larger wall thickness than the second layer region 10a. The functional device 8a has a plurality of first layer regions 10 in which channels for a tempering medium run. The functional device 8b has a plurality of first layer regions 10 which are filled with a foam. To this end, the functional device 8a is filled with an expandable filler which forms cavities when activating energy is supplied. The functional device 8c has a cavity structure, in particular a honeycomb structure, which is used for weight saving in the case of increased flexural stiffness of the first housing part 6.

FIG. 4 shows a schematic view of a first housing part 6 with first layer regions 10 and second layer regions 10a of the functional device. The first layer regions 10, also marked by means of the letter “H”, have a larger wall thickness than the second layer regions 10a, also marked by means of the letter “L”. Advantageously, the first support element 7 and the second support element 7a are constructed as support layers.

FIG. 5 schematically shows a section through a first housing part 6 with an in particular metallic insert 22 which extends both in the functional device 8 and outside of this functional device. The adjacent support elements are not illustrated in a simplified manner. The insert 22 is used for stiffening the first housing part 6, in particular increasing the flexural stiffness of the first housing part 6. The insert 22 is profiled for increased flexural stiffness.

FIG. 6 shows a schematic section through a preferred embodiment of a converter cell. An electrode assembly 2 is inserted into a first housing part and electrically connected to current conductors 14, 14a. Not illustrated are contact lugs which are used for the electrical connection between a current conductor 14, 14a and an electrode of the electrode assembly 2. Both current conductors 14, 14a have contacting regions 12, 12a. Of the first housing part, only the second polymer material 21 is illustrated. Support elements and functional devices are not illustrated, so that the contacting regions 12, 12a can be seen better. The contacting regions 12, 12a extend out of the second polymer material 21 in the direction of the functional device which is not illustrated. The contacting regions 12, 12a are used for the electrical connection, in particular the supply of the functional device which is not illustrated.

FIG. 7 schematically shows a processing device 2 for producing a layer composite 18 for a first housing part. The first support element 7, the second support element 7a and two functional devices 8, 8a are unwound from various supplies. Advantageously, the first support element 7 and the second support element 7a are constructed as support layers. These layers are fed to the processing device 20, here constructed as a double-belt press 20. Particularly under the action of heat, the layers which are laid on top of one another are connected to one another in the double-belt press 20 to form a layer composite 18. The layer composite 18 is fed to a supply 19.

FIG. 8 schematically shows a processing device 20 for producing a layer composite 18 for a preferred embodiment of a first housing part, with a plurality of functional devices, wherein one of these functional devices is constructed as a populated flexible circuit board 8a. Initially, the first functional device 8 is unwound. The circuit boards 8a are laid on to the first functional device 8 individually by a gripper, preferably with a minimum distance between two circuit boards. A further functional device 8b and also two support elements 7, 7a are unwound. Advantageously, the first support element 7 and the second support element 7a are constructed as support layers. The circuit board 8a is encompassed by the support elements 7, 7a before the layers of the double-belt press 20 are supplied. The layer composite 18 is created in the double-belt pressed 20 in particular under the action of heat. The layer composite 18 is fed to the supply 19.

FIG. 9 schematically shows the shortening of moulding blanks 23 of a prepared layer composite 18, in particular by means of a separating device 20. If one of the functional devices is constructed as a circuit board, the layer composite 18 is separated between two such circuit boards.

FIG. 10 schematically shows the production of a first housing part 6 from a moulding blank 23 with supplying a second polymer material 21 in the edge region of the moulding blank 23 or of the first housing part 6, with constructing an accommodation space 11 for an electrode assembly 2, with overmoulding of current conductors 14, 14a and of the edge region of the moulding blank 23, in a processing device 20. Although not illustrated, the moulding blank 23 has the first support element, at least one of these functional devices and also the second support element. Advantageously, the first support element 7 and the second support element 7a are constructed as support layers.

FIG. 10a shows the moulding blank 23 and also the current conductors 14, 14a which are inserted into the processing device, here constructed as a moulding tool 20. The two-part moulding tool is not yet closed. A part of the moulding tool 20 is constructed with a depression, the other part of the moulding tool 20 is constructed with an elevation. Depression and elevation are used for constructing an accommodation space in the moulding blank 23 or first housing part for the electrode assembly which is not illustrated. Before the moulding tool 20, equipped with depression and elevation, is closed, the moulding blank 23 is heated to a working temperature which at least corresponds to the softening temperature of the first polymer material.

FIG. 10b shows the moulding tool 20 during the closing process, wherein the accommodation space 11 is constructed in the moulding blank 23 by means of the depression and the elevation. In the process, the moulding blank 23 has a working temperature which at least corresponds to the softening temperature of the first polymer material.

FIG. 10c shows the closed moulding tool 20. The inserted moulding blank 23 has the accommodation space 11 after plastic shaping. The current conductors 14, 14a are held in the moulding tool 20 in predetermined positions with respect to the moulding blank 23, particularly in the edge region of the moulding blank 23. Preferably, the moulding blank 23 has a working temperature which at least corresponds to the softening temperature of the first polymer material, in particular so that the moulding blank 23 can begin an intimate material connection with the second polymer material which is not illustrated.

FIG. 10d shows the closed moulding tool 20 and also the inserted moulding blank 23 according to FIG. 10c at a later point in time. Heated second polymer material 21 is fed to the moulding tool 20 through two channels. The second polymer material 21 fills cavities provided in the moulding tool 20, which are arranged in edge regions of the moulding blank 23. The current conductors 14, 14a also extend through the cavities. With the feeding of the second polymer material 21, the edge regions of the moulding blank 23 and also the current conductors 14, 14a are overmoulded. Preferably, the moulding blank 23 has a working temperature which at least corresponds to the softening temperature of the first polymer material, in particular so that the moulding blank 23 can begin intimate material connections with the second polymer material 21.

After supplying the second polymer material 21, the temperature thereof and also the temperature of the shaped moulding blank 23 are lowered, so that the temperature also falls below the softening temperature of the first polymer material. The first housing part 6 is then ready for removal.

FIG. 10e shows the open moulding tool 20 and also the demoulded first housing part 6. The first housing part 6 has the two support elements, at least one of these functional devices, second polymer material 21 in the edge region, the accommodation space 11, and also the current conductors 14, 14a. After removing the first housing part 6, the moulding tool 20 is ready for producing the next first housing part.

FIG. 11 shows various views and sections of a first housing part 6 with an accommodation space 11 for an electrode assembly.

FIG. 12 schematically shows a converter cell 1 with a two-part cell housing 5, wherein the first housing part 6 is constructed as a cup and the second housing part 6a is constructed as a lid. The interior of the cup corresponds to the accommodation space 11. Not illustrated is the second polymer material, which is arranged in the edge regions of the housing parts 6, 6a. Two current conduction devices 4, 4a extend at least in certain areas through one of the housing parts into the surroundings of the converter cell 1.

FIG. 12a shows that the current conduction devices 4, 4a are guided through the second housing part 6a into the surroundings. It is not illustrated that the current conduction devices 4, 4a are connected to the second housing part 6a materially and in particular in a gas-tight manner.

FIG. 12b shows that the current conduction devices 4, 4a are guided through the first housing part 6 into the surroundings. It is not illustrated that the current conduction devices 4, 4a are connected to the first housing part 6 materially and in particular in a gas-tight manner.

FIG. 13 schematically shows a converter cell 1 with a two-part cell housing 5, wherein the housing parts 6, 6a are spaced by means of a frame made up of the second polymer material 21. The electrode assembly, which is not illustrated, is accommodated by the frame. Thus, the housing parts 6, 6a are each constructed without an accommodation space. Two of these current conduction devices 14, 14a extend out of the frame 21 into the surroundings of the converter cell 1.

FIG. 14 schematically shows further preferred embodiments of converter cells 1 in each case with a two-part cell housing 5 and each with two current conductors 14, 14a which extend into the surroundings of the converter cell 1. Edge regions of these housing parts 6, 6a are each encompassed by second polymer material 21. These edge regions are materially connected to one another, in particular in a gas-tight manner. Thus, the housing parts 6, 6a together form the cell housing around the electrode assembly which is not illustrated. Current conductors 14, 14a extend out of various housing parts 6, 6a, in particular each out of the second polymer material 21, which connects each of these current conductors to one in each case of these housing parts in a gas-tight manner. The housing parts 6, 6a are each constructed with one accommodation space. Advantageously, the two housing parts 6, 6a are constructed symmetrically. Thus, storage costs are reduced.

The FIGS. 14a and 14b show a converter cell 1, in which the current conductors 14, 14a extend in the same direction out of the cell housing.

The FIGS. 14c and 14d show a converter cell 1, in which the current conductors 14, 14a extend in opposite directions out of the cell housing.

FIG. 15 schematically shows further preferred embodiments of converter cells 1 in each case with a two-part cell housing 5 and with current conduction devices 4, 4a which essentially each terminate with a peripheral surface of the cell housing 5. Edge regions of these housing parts 6, 6a are each encompassed by second polymer material 21. These edge regions are materially connected to one another, in particular in a gas-tight manner. Thus, the housing parts 6, 6a together form the cell housing around the electrode assembly which is not illustrated. The current conduction devices 4, 4a are arranged in various housing parts 6, 6a, in particular each in the second polymer material 21, which connects each of these current conduction devices to one in each case of these housing parts in a gas-tight manner. The current conduction devices 4, 4a terminate with peripheral surfaces of various housing parts 6, 6a. The housing parts 6, 6a are each constructed with one accommodation space. Advantageously, the two housing parts 6, 6a are constructed symmetrically. Thus, storage costs are reduced.

The FIGS. 15a and 15b show a converter cell 1, in which the current conduction devices 4, 4a extend in the same direction.

The FIGS. 15c and 15d show a converter cell 1, in which the current conduction devices 4, 4a extend in opposite directions.

FIG. 16 schematically shows further preferred embodiments of converter cells 1 in each case with a two-part cell housing 5 each with a converter assembly 2 and two fluid ducts 24, 24a. Not illustrated are the current conduction devices of the converter cell 1. Edge regions of these housing parts 6, 6a are each encompassed by second polymer material 21. These edge regions are materially connected to one another, in particular in a gas-tight manner. Thus, the housing parts 6, 6a together form the cell housing around the converter assembly 2 which is not illustrated. The fluid ducts 24, 24a extend out of the cell housing, in particular out of the second polymer material into the surroundings of the converter cell 1. The first fluid duct 24 is used for supplying the fuel. The second fluid duct 24a is used both for supplying the oxidising agent and draining the educt. To this end, the second fluid duct 24a has a partition which is not illustrated.

The FIGS. 16a and 16c show a converter cell 1, the fluid ducts 24, 24a of which extend in the same direction.

The FIGS. 16c and 16d show a converter cell 1, the fluid ducts 24, 24a of which extend in opposite directions.

FIG. 17 schematically shows a section through a first housing part 6 with two of these functional devices 8, 8a and this insulating device 26. The functional devices 8, 8a and also the insulating device 26 are encompassed by the first support element 7 and the second support element 7a. Advantageously, the first support element 7 and the second support element 7a are constructed as support layers with a fibre-permeated polymer material. The insulating device 26 spaces the first functional device 8 from the second functional device 8a and has a recess 25. The first functional device 8 and the second functional device 8a are constructed as metal films. The first functional device 8 and the second functional device 8a each have at least one of these electrode connection regions 9, 9a as functional elements for electrically connecting to electrodes of different polarity of an electrode assembly which is not illustrated. In addition, the second functional device 8a has a recess 25a which is arranged adjacently to the recess 25 of the insulating device 26 and exposes the electrode connection region 9 opposite the current conduction device which is not illustrated. The second support element 7a has two contacting recesses 17, 17a which expose the electrode connection regions 9, 9a opposite the current conduction devices which are not illustrated. The current conduction devices, which are not illustrated, each have one contacting region, wherein the contacting regions extend through the contacting recesses 17, 17a and also the recesses 25, 25a of the second 8a functional device and the insulating device 26 as far as the electrode connection regions 9, 9a and are connected to the same.

If a foreign body penetrates into the first housing part 6 and in the process changes the insulating device 26 to its second state, an electric current can flow between the functional devices 8, 8a and thus between the electrodes of different polarity of the electrode assembly. In the process, at least part of the stored energy is removed from the electrode assembly and in particular converted into heat energy.

### LIST OF REFERENCE NUMBERS

1 Converter cell
2 Electrode assembly, converter assembly
3, 3a Electrode
4, 4a Current conduction device
5 Cell housing
6, 6a, 6b Housing part
7, 7a Support element
8, 8a, 8b Functional device
9, 9a Functional element
10, 10a Layer region
11 Accommodation space
12, 12a Contacting region
13 Contact lug
14, 14a Current conductor
15, 15a Pole contact recess
16, 16a Pole contact region
17, 17a Contacting recess
18 Layer composite
19 Supply
20 Processing device, moulding tool
21 Second polymer material, frame made up of second polymer material
22 Insert
23 Moulding blank
24, 24a Fluid duct
25, 25a Recess
26 Insulating device

1. An electrochemical energy converter device, in the following also called a converter cell (1), with at least
one in particular rechargeable electrode assembly (2), which is provided to provide electrical energy at least intermittently to a consumer in particular, which has at least two electrodes (3, 3a) of different polarity, which is preferably provided to convert chemical energy into electrical energy at least intermittently, which is preferably provided to convert supplied electrical energy in particular into chemical energy at least intermittently,
a current conduction device (4, 4a), which is provided to be electrically, preferably materially connected to one of the electrodes (3, 3a) of the electrode assembly (2),
a cell housing (5) with a first housing part (6), wherein the cell housing (5) is provided to encompass the electrode assembly (2) at least in certain areas,
wherein the first housing part (6) at least has
a functional device (8, 8a, 8b), which is provided to support the release of energy from the electrode assembly (2), in particular to a consumer, which is operatively connected to the electrode assembly (2), in particular for the absorption of energy,
a first support element (7) which is provided to support the at least one functional device (8, 8a, 8b).

2. The converter cell (1) according to claim 1, characterised in that
the first housing part (6) has at least one second support element (7a), wherein the second support element (7a) is provided to support at least one of these functional devices (8, 8a),
the first housing part (6) has at least two of these functional devices (8, 8 5 a) and an insulating device (26), wherein the two functional devices (8, 8a) and the insulating device (26) are arranged between the first support element (7) and the second support element (7a),
the first functional device (8) and the second functional device (8a) are constructed to be electrically conductive, preferably are constructed as metal films in each case,
the first functional device (8) is in particular electrically connected to one of the electrodes (3) of first polarity of the electrode assembly (2) and the second functional device (8a) is electrically connected to one of the electrodes (3a) of second polarity of the electrode assembly (2),
the insulating device (26) is configured to at least temporarily electrically insulate the first functional device (8) with respect to the second functional device (8a), wherein this configuration of the insulating device (26) is called the first state in the following,
the insulating device (26) is constructed with an electrically insulating material, and arranged between the first functional device (8) and the second functional device (8a), preferably is constructed as an electrically insulating layer, particularly preferably is constructed as an electrically insulating coating of the first functional device (8) and/or the second functional device (8a),
the insulating device (26) is provided to be changed from the first state to a second state, in particular by means of a foreign body not belonging to the converter cell, wherein the insulating device (26) does not electrically insulate the first functional device (8) with respect to the second functional device (26) in the second state, wherein preferably in the second state the first functional device (8) is electrically connected to the second functional device (8a).

3. The converter cell (1) according to claim 1, characterised in that the at least one functional device (8, 8a, 8b) has at least one functional element (9, 9a), wherein the at least one functional element (9, 9a) is operatively connected, in particular electrically connected, to the electrode assembly (2), wherein preferably the at least one functional element (9, 9a) is constructed as: a pole contact region (16, 16a), electrode connection region, conductor track, recess (14, 14a), voltage probe, current probe, temperature probe, pressure sensor, substance sensor, gas sensor, liquid sensor, position sensor, acceleration sensor, control device, application-specific integrated circuit, microprocessor, switching device, circuit breaker, current limiter, discharge resistance, pressure-release device, fluid duct, adjustment device, actuator, data storage device, beeper, light-emitting diode, infrared interface, GSM module, first short-range radio device or transponder.

4. The converter cell (1) according to claim 1, characterised in that the at least one functional device (8, 8a, 8b) at least
is constructed porously to some extent, particularly preferably with a foam, and/or
in certain areas has a cavity structure, in particular a honeycomb structure, and/or
has a cavity for a tempering medium, and/or
has an expandable filler in certain areas, which is provided in particular to construct cavities when activation energy is supplied or to construct cavities in a manner triggered by a functional element (9, 9a), and/or
has a filler in certain areas with the capacity for phase change (PCM) in particular within the predetermined operating temperature range of the converter cell (1), and/or
at least in certain areas has a chemically reactive filler which is preferably provided to chemically bond a substance in particular from the electrode assembly (2), particularly preferably after the release of the substance from the electrode assembly (2), and/or
has a first layer region (10) with a first wall thickness (thick) and a second layer region (10a) with a second wall thickness (thin), wherein the fraction made up of the second wall thickness over the first wall thickness has a predetermined value smaller than 1, wherein the first layer region (10) preferably has a lower density than the second layer region (10a).

5. The converter cell (1) according to claim 1, the cell housing (5) of which has a second housing part (6a), wherein the second housing part (6a)
is provided to be in particular materially connected at least in certain areas to the first housing part (6),
is provided to form the cell housing (5) of the converter cell (1) with the first housing part (6),
has a first support element (7) which is provided to delimit the electrode assembly (2) with respect to the surroundings of the converter cell (1),
preferably has at least one functional device (8, 8a, 8b), which is provided to support the release of energy, in particular to a consumer, which is operatively connected to the electrode assembly (2), in particular for the absorption of energy.

6. The converter cell (1) according to claim 1, characterised in that the first housing part (6) and/or the second housing part (6a)
has an accommodation space (11) which is provided to accommodate the electrode assembly (2) at least to some extent, and/or
has a second support element (7a) which is in particular arranged adjacently to the functional device (8) and faces the electrode assembly (2), which preferably has an in particular fibre-permeated first polymer material, in particular for stiffening the second support element (7a), wherein preferably the second support element (7a) has a contacting recess (17, 17a), and/or
has a second polymer material (21) in an edge region of the housing part, wherein the second polymer material (21) is used in particular for materially connecting to a different housing part (6a, 6b), wherein preferably the second polymer material (21) is constructed as a thermoplastic.

7. The converter cell (1) according to claim 1, the cell housing (5) of which has an essentially plate-shaped third housing part (6b), wherein the third housing part (6b)
is provided to be connected at least in certain areas to the first housing part (6) in particular materially to the cell housing (5), and/or
has an increased thermal conductivity compared to the first housing part (6), preferably has a metal, particularly preferably aluminium and/or copper, and/or
has a first heat transfer region, which is provided to exchange heat energy with the electrode assembly (2), and/or
preferably has a second heat transfer region, which is provided to exchange heat energy with a temperature control device not belonging to the converter cell (1).

8. The converter cell (1) according to claim 1, characterised in that the at least one current conduction device (4, 4a) has a contacting region (12, 12a), wherein the contacting region (12, 12a)
is used for the electrical contacting, preferably the electrical supply of the functional device (8), and/or
is preferably arranged in an edge region of the first housing part (6), and/or
preferably extends in the direction of the functional device (8), and/or
is preferably constructed by means of a shaping method, particularly preferably as a projection.

9. The converter cell (1) according to claim 1, characterised in that the at least one of these current conduction devices (4, 4a)
has at least one contact lug (13, 13a), which is preferably materially connected to one of the electrodes (3, 3a) of the electrode assembly (2),
preferably has a current conductor (14, 14a) which extends at least to some extent into the interior of the cell housing (5), which particularly preferably extends at least to some extent out of the cell housing (5) into the surroundings of the converter cell (1), which is in particular materially connected to the at least one contact lug (13, 13a).

10. The converter cell (1) according to claim 1, characterised in that
at least one of these functional devices (8, 8a, 8b) is arranged between the first support element (7) and the second support element (7a), preferably is materially connected to the first support element (7) and the second support element (7a) at least in certain areas,
the first support element (7) has at least one pole contact recess (15, 15a) which in particular makes a region of the adjacent functional device (8) accessible, in particular electrically contactable, from the surroundings of the converter cell (1),
at least one of these functional devices (8, 8a, 8b) has at least one of these pole contact regions (16, 16a) in particular in the region of the at least one pole contact recess (15, 15a), which has the potential of one of the electrodes (3, 3a) of the electrode assembly (2), which is preferably used for electrically connecting this electrode (3, 3a) to a different converter cell (1) or to a consumer,
the second support element (7a) has a contacting recess (17, 17a) adjacent to the contacting region (12, 12a) of the current conduction device (4, 4a),
the functional device (8, 8a, 8b) has the electrode connection region as functional element (9, 9a) in particular in the region of the contacting recess (17, 17a), which in particular faces the current conduction device (4, 4a), preferably the contacting region (12, 12a) thereof,
an electrical connection between the current conduction device (4, 4a), in particular the contacting region (12, 12a) thereof, and the functional device (8) is in particular constructed for electrically supplying the functional device (8) or at least one of the functional elements (9, 9a) by means of the electrode assembly (2).

11. The converter cell (1) according to claim 1, characterised by a housing assembly with the first housing part (6) and at least one of these current conduction devices (4, 4a), preferably two of these current conduction devices (4, 4a), which are connected to electrodes (3, 3a) of different polarity, wherein
the first housing part (6) has an in particular materially connected layer composite (18, 18a) made up of at least the first support element (7), at least one functional device (8) with at least one functional element (9, 9a) and the second support element (7a),
the first housing part (6) has a second polymer material (21) in particular in the edge region, wherein preferably the edge region is encompassed by the second polymer material (21) at least in certain areas,
the first housing part (6) has an accommodation space (11), wherein the accommodation space (11) is provided to accommodate the electrode assembly (2) at least to some extent,
at least one of these current conduction devices (4, 4a) has the contacting region (12, 12a), wherein the contacting region (12, 12a) is arranged in the edge region of the first housing part (6), preferably in the second polymer material (21),
the second support element (7a) has the contacting recess (17, 17a) in the contacting region (12, 12a) of at least one of these current conduction devices (4, 4a),
the contacting region (12, 12a) is in particular electrically connected through the contacting recess (17, 17a) to the functional device (8, 8a, 8b), in particular to the electrode connection region (9, 9a) thereof.

12. The converter cell (1) according to claim 1, characterised in that
the at least one of these functional devices (8, 8a, 8b) has one of these cell control devices (9b) and at least one of these measurement probes (9c),
the at least one measuring probe (9c) is provided to detect an operating parameter of the converter cell (1), particularly of the electrode assembly (2) and to supply the same to the cell control device (9b),
the cell control device (9c) is provided to control at least one operating method of the converter cell (1), in particular the charging and/or discharging of the electrode assembly (2), preferably to monitor an operating state of the converter cell (1).

13. The converter cell (1) according to claim 1, characterised by
preferably a nominal charging capacity of at least 10 Ah, and/or
a nominal current of at least 50 A, preferably of at least 100 A, and/or
a nominal voltage of at least 3.5 V, and/or
an operating temperature range of −40° C. to +100° C., and/or
preferably a gravimetric energy density of at least 50 Wh/kg.

14. A battery with at least two converter cells (1) according to claim 1, with a battery control and preferably with a second short-range radio device.

15. A method for producing an electrochemical energy converter device, in particular according to claim 1, wherein the electrochemical energy converter device, in the following also called a converter cell (1), at least has:
an electrode assembly (2) with at least two electrodes (3, 3a) of different polarity,
at least one or two current conduction devices (4, 4a), wherein the first current conduction device (4) is connected to the electrode of first polarity (3) and the second current conduction device (4a) is connected to the electrode of second polarity (3a), preferably at least one of these current conduction devices (4, 4a) has at least one contact lug (13, 13a), particularly preferably a current conductor (14, 14a), preferably at least one of these current conduction devices (4, 4a) has a contacting region (12, 12a),
a cell housing (5) with a first housing part (6), preferably also a second housing part (6a) or third housing part (6b), wherein the first housing part (6) has a first support element (7) and at least one functional device (8, 8a, 8b) with at least one functional element (9, 9a, 9b, 9c), wherein the first support element (7) is used for supporting the at least one functional device (8, 8a, 8b), wherein the first support element (7) has a first polymer material and preferably a fibre material, wherein the at least one functional device (8, 8a, 8b) is in particular materially connected to the first support element (7) at least in certain areas, wherein at least one of these functional devices (8, 8a, 8b) is operatively connected, preferably electrically connected, to the electrode assembly (2), wherein preferably the first housing part (6) has a second support element (7a) which is arranged between the at least one functional device (8, 8a, 8b) and the electrode assembly (2), and which is particularly preferably, in particular materially, connected to one of these functional devices (8, 8a, 8b), wherein preferably the first housing part (6) has a second polymer material (21) in an edge region,
wherein the method is in particular used for closing the cell housing (5) around the electrode assembly (2), characterised by the following steps:
(S17) providing the first housing part (6) or the in particular shaped moulding blank (23), preferably in a processing device (20), which is used in particular for constructing the cell housing (6) around the electrode assembly (2),
(S19) supplying the electrode assembly (2), which preferably has at least one or a plurality of these contact lugs (13, 13a), to the first housing part (6) preferably into the processing device (20), in particular inserting the electrode assembly (2) into the accommodation space (11) of the first housing part (6),
(S20) electrically connecting the electrode assembly (2) to at least one or a plurality of these current conduction devices (4, 4a), in particular by means of a joining method, preferably by means of a friction welding method, particularly preferably by means of ultrasonic welding,
(S23) supplying the second housing part (6a) to the first housing part (6), wherein the second housing part (6a) preferably has the second polymer material (21) in an edge region,
(S26) in particular materially connecting the second housing part (6a) or the third housing part (6b) to the first housing part (6), in particular under the action of heat, in particular at a working temperature which at least corresponds to the softening temperature of the second polymer material (21), wherein an edge region of the first housing part (6) is preferably connected to the second housing part (6a) or the third housing part (6b),
preferably with
(S25) heating in particular of the edge region of the in particular first housing part to a working temperature, which preferably at least corresponds to the softening temperature of the second polymer material,
wherein preferably executed instead of step S23 is:
(S24) supplying the third housing part (6b) to the first housing part (6), wherein a first heat transfer region of the third housing part (6b) is preferably arranged adjacently to the electrode assembly (2), particularly preferably is brought into thermal contact with the electrode assembly (2),
wherein preferably executed instead of step S26 is:
(S26′) in particular materially connecting the second housing part or the third housing part to the first housing part, in particular with the use of a sealant and/or adhesive, wherein an edge region of the first housing part is preferably connected to the second housing part or the third housing part, or
(S26″) in particular materially connecting the second housing part or the third housing part to the first housing part, preferably whilst feeding an in particular flowable second polymer material, preferably under the action of heat and at a differential pressure with respect to the surroundings of the processing device, in particular into the moulding tool, wherein the second polymer material is arranged in the edge region of the at least one of the housing parts, in particular at temperature which at least corresponds to the softening temperature of the second polymer material, wherein preferably for each one of these contacting regions at least one or two of these current conduction devices is exposed, wherein preferably an edge region of the first housing part is connected to the second housing part or the third housing part, in particular after step S25.

16. The method in particular according to claim 15, in particular for producing the converter cell (1), in particular for producing the first or second housing part (6, 6a), characterised by the steps:
(S11) feeding the essentially planar moulding blank (23) into a processing device (20), in particular into a moulding tool,
(S12) inserting at least one or a plurality of these current conduction devices (4, 4a), preferably inserting at least one or a plurality of these current conductors (14, 14a), into the processing device (20), in particular into the moulding tool, in particular for the essentially planar moulding blank (23),
(S14) feeding an in particular flowable second polymer material (21), preferably under the action of heat and preferably with a differential pressure with respect to the surrounding air pressure for the moulding blank (23), into the processing device (20), in particular into the moulding tool, wherein the second polymer material (21) is arranged in the edge region of the moulding blank (23), in particular at a working temperature which at least corresponds to the softening temperature of the second polymer material (21), wherein preferably for each one of these contacting regions (12, 12a), at least one or two of these current conduction devices (14, 14a) is exposed,
(S15) solidifying the shaped moulding blank (23), preferably by means of cooling to a removal temperature, which is in particular below the softening temperature of the first polymer material, which is in particular below the softening temperature of the second polymer material (21),
(S16) removing the in particular shaped moulding blank (23), in the following also called the first housing part (6), from the processing device (20), in particular at a removal temperature, which is below the softening temperature of the first polymer material, preferably with at least one of the steps:
(S10) heating the essentially planar moulding blank (23), preferably to a working temperature which at least corresponds to the softening temperature of the first polymer material of the first support element (7), in particular in the processing device (20), and/or
(S13) constructing an accommodation space (11) from the electrode assembly (2) in the moulding blank, in particular in the processing device (20), in particular by means of shaping the in particular heated moulding blank (23) with a body, wherein the accommodation space (11) is adapted to the shape of the electrode assembly (2), which preferably essentially corresponds to the shape of the electrode assembly (2), which particularly preferably is created by closing the moulding tool.

17. The method in particular according to claim 15, in particular for producing a layer composite (18, 18a) for the first or second housing part (6, 6a), wherein the layer composite (18, 18a) has the first support element (7), at least one or a plurality of these functional devices (8, 8a, 8b) and preferably the second support element (7a), characterized by the steps:
(S2) providing the first support element (7), preferably from a second supply, which support element has an in particular fibre-permeated first polymer material, which preferably has one or two of these pole contact recesses (15, 15a), wherein one or two of these pole contact recesses (15, 15a) is adjacent to one each of these pole contact regions (16, 16a),
(S3) laying at least one or a plurality of these functional devices (8, 8a, 8b) or functional assemblies, preferably from the first supply, onto the first support element (7), or one of these functional devices (8, 8a, 8b), wherein at least one populated, in particular flexible circuit board is preferably laid onto the first support element (7) as functional device (8, 8a, 8b), wherein particularly preferably the circuit board has the functional elements (9, 9a, 9b, 9c) according to the first preferred configuration of the functional device (8, 8a, 8b),
(S4) in particular materially connecting the first support element (7) to at least one of these functional devices (8, 8a, 8b), preferably under the action of heat, preferably by means of an isotactic or continuous press (20), whereupon the layer composite (18, 18a) is formed, preferably with at least one of the steps:
(S1) creating at least one or a plurality of these functional devices (8, 8a, 8b) with at least one or a plurality of these functional elements (9, 9a, 9b, 9c), wherein preferably at least one or two of these functional elements (9, 9a, 9b, 9c) is constructed as an electrode connection region or as a pole contact region (16, 16a), preferably supply of the at least one or a plurality of these functional devices (8, 8a, 8b) to a first supply, or
(S1′) creating at least one or a plurality of these functional devices (8, 8a, 8b) with at least one or a plurality of these functional elements (9, 9a, 9b, 9c), wherein preferably at least one or two of these functional elements (9, 9a, 9b, 9c) is constructed as an electrode connection region or as a pole contact region (16, 16a), wherein introduced into the at least one of these functional devices (8, 8a, 8b) is: a foam, a cavity structure, in particular a honeycomb structure, at least one cavity for a tempering medium, a filler with the capacity for phase change and/or a chemically reactive filler, preferably supply of at least one or a plurality of these functional devices (8, 8a, 8b) to a first supply, or
(S1″) creating at least one or a plurality of these functional devices (8, 8a, 8b) with at least one or a plurality of these functional elements (9, 9a, 9b, 9c), wherein preferably at least one or two of these functional elements (9, 9a, 9b, 9c) is constructed as an electrode connection region or as a pole contact region (16, 16a), wherein at least one or a plurality of these functional devices (8, 8a, 8b) is produced with a first layer region (10) with a first wall thickness (thick) and a second layer region (10a) with a second wall thickness (thin), wherein the fraction made up of the second wall thickness over the first wall thickness has a predetermined value smaller than 1, particularly preferably the first layer region (10) has a lower density than the second layer region (10a), preferably supply of at least one or a plurality of these functional devices (8, 8a, 8b) to a first supply,
preferably with the steps
(S5) laying a second support element (7a) onto one of these functional devices (8, 8a, 8b), wherein the second support element (7a) has an in particular fibre-permeated first polymer material, preferably from a third supply, wherein the second support element (7a) preferably has one or two contacting recesses (17, 17a), and
(S6) connecting the second support element (7a) to one of these functional devices (8, 8a, 8b), in particular to the adjacent functional device, preferably under the action of heat, preferably by means of an isotactic or continuous press (20),
particularly preferably with step
(S27) combining a plurality of these functional elements (9, 9a) in one of these functional devices (8, 8a, 8b), as a result of which a functional assembly is formed in particular.

18. The method in particular according to claim 15, in particular for closing the cell housing (5) around the electrode assembly (2), in particular for producing the first preferred development of the first preferred embodiment of the converter cell (1), characterised by the steps:
S11, wherein one of these moulding blanks (23) is supplied with one of these functional devices (8, 8a, 8b) to a processing device (20), wherein this functional device (8, 8a, 8b) has at least one of these electrode connection regions (9)
S12, wherein one or preferably two of these current conduction devices (4, 4a) or the current conductors (14, 14a) thereof are passed into the moulding tool (20) to this moulding blank (23) and there arranged in the edge region of the moulding blank (23) or of the future first housing part (6)
preferably S22, wherein at least one of these contacting regions (12, 12a) of one of these current conduction devices (4, 4a) or of one of these current conductors (12, 12a) is electrically connected to at least one of these electrode connection regions of the functional device (8, 8a, 8b),
S10, S13 and S14, wherein preferably S10 is executed temporally before S13 and preferably S13 is executed simultaneously with S14, whereupon the moulding blank (23) receives an accommodation space (11) for the electrode assembly (2) and second polymer material (21) is arranged in the edge region (23) of the moulding blank in such a manner that the inserted current conduction devices (4, 4a) or the current conductors (12, 12a) thereof are encompassed by the second polymer material (23) in particular in a gas-tight manner,
S15, whereupon softened first polymer material of the first support element (7) becomes solid again and the resulting first housing part (6) can be removed from the moulding tool (20),
S18, for equipping the electrode assembly (2) with at least one or a plurality of these contact lugs (13), wherein the contact lugs (13) are connected to at least one of these electrodes (3) of first polarity or to at least this of the electrodes (3a) of second polarity,
S17 and S19, whereby the electrode assembly (2) is supplied to the first housing part (6) provided in the processing device (20), preferably is arranged in the accommodation space (11) of the first housing part (6),
S21, wherein these contact lugs (13) which are connected to these electrodes (3) of first polarity, and these contact lugs (13a) which are connected to these electrodes (3b) of second polarity, are electrically connected to various current conductors (14, 14a), in particular by means of a joining method,
S23, wherein the second housing part (6a) is inserted into the processing device (20) towards the first housing part (6) and towards the electrode assembly (2), wherein at least one of these edge regions of the first housing part (6) and at least one of these edge regions of the second housing part (6a) are arranged adjacently to one another.
preferably S25, wherein the edge region in particular of the in particular first housing part (6) is heated to a working temperature, which preferably at least corresponds to the softening temperature of the second polymer material (21),
S26, wherein the edge regions in particular, preferably the second polymer materials (21) of the first housing part (6) and of the second housing part (6a) are in particular materially connected to one another, in particular at a working temperature which at least corresponds to the softening temperature of the second polymer material (21).

19. The method in particular according to claim 15, particularly for producing one of these first or second housing parts in particular for a converter cell, wherein
the first housing part (6) and/or the second housing part (6a) in each case has two of these functional devices (8, 8a) and this insulating device (26) between the first support element (7) and the second support element (7a),
the first functional device (8) and the second functional device (8a) are constructed as electrical conductors, preferably as metal films, and each with one of these electrode connection regions,
the insulating device (26) is constructed as insulating layer between the first (8) and the second functional device (8a) and is arranged adjacently to the electrode connection region of the first functional device (8) with one of these recesses (25),
the second functional device (8a) is constructed adjacently to the recess (25) of the insulating device (26) with one of these recesses (25a),
the second support element (7a), which is arranged adjacently to the second functional device (8a), has one contacting recess each (17, 17a) adjacent to the electrode connection regions of the first functional device (8) and the second functional device (8a),
characterised by the steps:
S1, the step is executed multiple times, wherein initially the first functional device (8) is constructed at least with one of these electrode connection regions, subsequently the third functional device (8b) is constructed at least with one of these electrode connection regions and with this recess (25a),
S29, creating one of these insulating devices (26), preferably as an insulating ply, preferably with a recess (25),
S2,
S3, this step is executed multiple times, wherein initially the first functional device (8) is laid onto the first support element (7), subsequently the second functional device (26) is laid onto the insulating device (26),
S3′, wherein the insulating device (26) is laid onto the first functional device (8),
preferably S4, in particular whereby this layer composite (18) is formed,
S5,
preferably S6, whereby the second support element (7a) is supplied to this layer composite (18),
wherein during the steps S3 and S3′, the recesses (25, 25a) of the second functional device (8a) and the insulating device (26) are arranged with the contacting recesses (17, 17a) of the second support element (7a) in such a manner that the electrode connection regions of the first (8) and second functional device (8a) are exposed through the mentioned recesses (25, 25a) and contacting recesses (17, 17a) opposite the current conduction devices (4, 4a),
whereupon a layer composite (18) with the first support element (7), these two functional devices (8, 8a), the insulating device and the second support element (7a) is formed,
with the further steps
preferably S8 and/or S9,
S11, S12, S14, S15, S16,
preferably S13, particularly preferably S10,
preferably the following steps subsequently take place:
S18, for equipping the electrode assembly (2) with at least one or a plurality of these contact lugs (13), wherein the contact lugs (13) are connected to at least one of these electrodes (3) of first polarity or to at least this of the electrodes (3a) of second polarity,
S17 and S19, whereby the electrode assembly (2) is supplied to the first housing part (6) provided in the processing device (20), preferably is arranged in the accommodation space (11) of the first housing part (6),
S21, wherein these contact lugs (13) which are connected to these electrodes (3) of first polarity, and these contact lugs (13a) which are connected to these electrodes (3b) of second polarity, are electrically connected to various current conductors (14, 14a), in particular by means of a joining method,
S23, wherein the second housing part (6a) is inserted into the processing device (20) towards the first housing part (6) and towards the electrode assembly (2), wherein at least one of these edge regions of the first housing part (6) and at least one of these edge regions of the second housing part (6a) are arranged adjacently to one another,
preferably S25, wherein the edge region in particular of the in particular first housing part (6) is heated to a working temperature, which preferably at least corresponds to the softening temperature of the second polymer material (21),
S26, wherein the edge regions in particular, preferably the second polymer materials (21) of the first housing part (6) and of the second housing part (6a) are in particular materially connected to one another, in particular at a working temperature which at least corresponds to the softening temperature of the second polymer material (21).
